(19) United States
(12) Patent Application Publication
(10) Pub. No.: US 2026/0133952 A1
(43) Pub. Date: May 14, 2026

(54) SYSTEMS AND METHODS FOR AUTOMATED USER RELATIONSHIP PROFILING

(71) Applicant: PANASONIC WELL LLC, Palo Alto, CA (US)

(72) Inventors: David Justus, Brooklyn, NY (US); Prerna Kaul, Palo Alto, CA (US); Katlyn Bren Johnson, Palo Alto, CA (US); Mary Christine Virginia Baynham Pitts, Palo Alto, CA (US); Peter Markatos, Palo Alto, CA (US); Anisha Kharkia, Palo Alto, CA (US); Dipti Rai, Pleasanton, CA (US)

(21) Appl. No.: 19/340,539

(22) Filed: Sep. 25, 2025

Related U.S. Application Data
(60) Provisional application No. 63/720,584, filed on Nov. 14, 2024.

(51) Int. Cl. G06F 16/23; G06F 40/35; G06F 40/40

(52) U.S. Cl. CPC G06F 16/23; G06F 40/35; G06F 40/40

(57) ABSTRACT

Systems and methods for automatically and continuously evaluating user data collected through different communications sessions and other data sources to perform user profiling and define familiar relationships amongst users.

### CROSS-REFERENCE TO RELATED APPLICATIONS

The present application claims the benefit of U.S. Provisional Application 63/720,584 filed Nov. 14, 2024 and is related to U.S. Non-Provisional Application entitled “SYSTEMS AND METHODS FOR PROACTIVE ARTIFICIAL INTELLIGENCE” filed Sep. 25, 2025 (Attorney Docket No.: 109304-847304-008700US), U.S. Non-Provisional Application entitled “SYSTEMS AND METHODS FOR DYNAMIC CONVERSATIONAL INTERFACES ACCORDING TO DETECTED USER BEHAVIORS” filed Sep. 25, 2025 (Attorney Docket No.: 109304-847284-009300US) and U.S. Non-Provisional Application entitled “MACHINE-LEARNING TECHNIQUES FOR FAMILY PROFILE MANAGEMENT” filed Sep. 25, 2025 (Attorney Docket No.: 109304-847282-009400US), each of which are incorporated herein by reference in their entireties and for all purposes.

### FIELD

The present disclosure relates to systems and methods for automatically and continuously evaluating user data collected through different communications sessions and other data sources to perform user profiling and define familiar relationships amongst users.

### SUMMARY

Disclosed embodiments provide a framework for automatically and continuously processing communications exchanged during different communications sessions and other data sources to extract data usable to perform user profiling and to define familial relationships amongst different users that may be engaged, or otherwise referred to, in these different communications sessions. According to some embodiments, a computer-implemented method is provided. The computer-implemented method comprises obtaining conversation data. The conversation data corresponds to an ongoing communications session between a set of users and an automated agent. The computer-implemented method further comprises converting the conversation data into a set of key-value pairs of inferred user attributes. The conversation data is converted into the set of key-value pairs using one or more large language models (LLMs) dynamically trained to extract different inferred user attributes from different conversation data. The computer-implemented method further comprises evaluating a set of profiles to identify a set of existing attributes associated with the set of users and to a family unit. The family unit is a grouping of the set of users. The computer-implemented method further comprises updating the set of profiles. The set of profiles is updated by processing the set of key-value pairs and the set of existing attributes to generate a set of merged attributes corresponding to the set of users and the family unit. Furthermore, the set of merged attributes is generated by verifying feedback corresponding to the set of existing attributes. The computer-implemented method further comprises processing the updated set of profiles through a trained machine learning algorithm to identify one or more tasks for improving a set of metrics associated with the family unit. The computer-implemented method further comprises providing the one or more tasks through the ongoing communications session.

In some embodiments, the computer-implemented method further comprises monitoring in real-time performance of the one or more tasks. The computer-implemented method further comprises dynamically performing one or more actions to improve the performance of the one or more tasks. The one or more actions are performed based on the set of profiles.

In some embodiments, the computer-implemented method further comprises generating a new profile corresponding to a new user associated with the family unit. The new profile is generated based on a determination that a subset of the set of key-value pairs does not correspond to an existing user from the set of users.

In some embodiments, the one or more LLMs are further dynamically trained to generate prompts for additional conversation data. Furthermore, the prompts are generated based on a context of the conversation data and the key-value pairs.

In some embodiments, the computer-implemented method further comprises calculating inference confidence scores for set of key-value pairs. An inference confidence score denotes a likelihood that a corresponding inferred user attribute can be associated with a user profile. The computer-implemented method further comprises processing the inference confidence scores against existing inference confidence scores corresponding to the set of existing attributes to generate the set of merged attributes.

In some embodiments, the set of profiles is updated according to a knowledge graph and a vector store. Furthermore, the knowledge graph and the vector store provide indications of previously verified and previously rejected user attributes.

In some embodiments, the computer-implemented method further comprises identifying a set of idiosyncrasies corresponding to set of users. The set of idiosyncrasies is identified based on the updated set of profiles. The computer-implemented method further comprises generating one or more motivators according to the set of idiosyncrasies. The one or more motivators are provided with the one or more tasks to motivate the set of users to complete the one or more tasks.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which a family-based wellness service dynamically processes real-time conversations between different family members and data from third-party data sources to generate family-based user profiles and to define relationships among the family-based user profiles in accordance with at least one embodiment;

FIG. 2 shows an illustrative example of an environment in which a family profiling system dynamically processes raw data from different data sources to extract inferred user preferences and attributes for updating different family-based user profiles and to further define relationships among the family-based user profiles in accordance with at least one embodiment;

FIG. 3 shows an illustrative example of an environment in which a profile attribute generator evaluates proposed family attributes to determine whether to merge the proposed family attributes with known attributes within existing family-based user profiles in accordance with at least one embodiment;

FIGS. 4A-4E show an illustrative example of an environment in which a profile attribute generator dynamically generates and updates different family-based user profiles corresponding to a family unit based on real-time communications exchanged between a family member and an automated agent in accordance with at least one embodiment;

FIG. 5 shows an illustrative example of a process for generating user profile attributes and family-based attribute relationships based on initial conversation data between one or more users and an automated agent in accordance with at least one embodiment;

FIG. 6 shows an illustrative example of a process for updating different family-based user profiles and corresponding relationships among the different family-based user profiles based on raw data associated with one or more users in accordance with at least one embodiment;

FIG. 7 shows an illustrative example of a process for maintaining different preferences and attributes corresponding to family-based user profiles over time in accordance with at least one embodiment;

FIG. 8 shows an illustrative example of an environment in which communications with members are processed in accordance with at least one embodiment; and

FIG. 9 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework for automatically and continuously evaluating user data collected through different communications sessions and other data sources to perform user profiling and define familiar relationships amongst users.

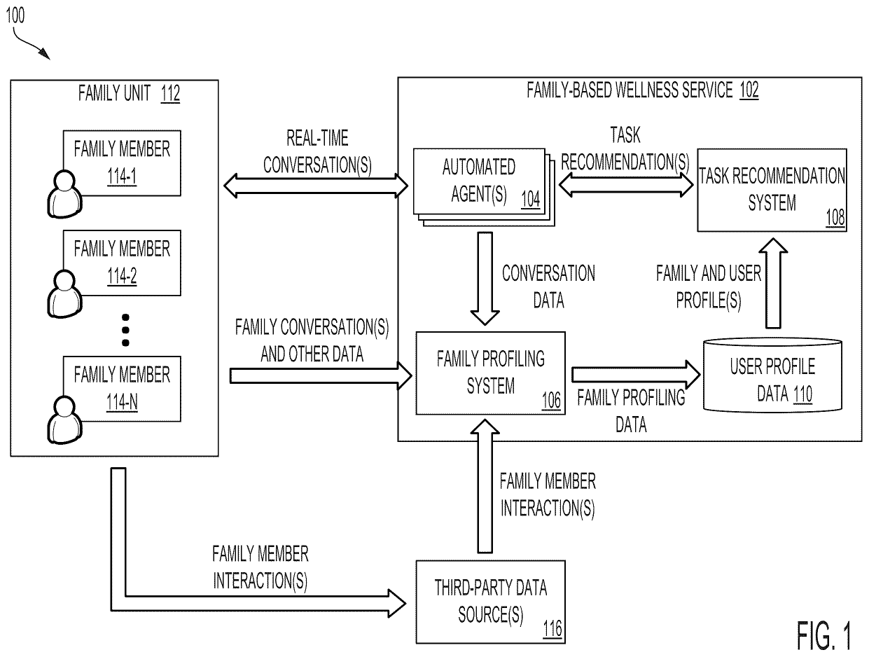

FIG. 1 shows an illustrative example of an environment 100 in which a family-based wellness service 102 dynamically processes real-time conversations and other media (e.g., images, audiovisual recordings, etc.) shared between different family members 114-1-114-N and structured and unstructured data from third-party data sources 116 to generate family-based user profiles and to define relationships among the family-based user profiles in accordance with at least one embodiment. In the environment 100, one or more family members 114-1-114-N may be engaged with an automated agent 104 implemented by a family-based wellness service 102. For instance, when a family member (such as a parent or other head of a family unit 112) accesses the family-based wellness service 102 for the first time, the family-based wellness service 102 may implement and assign an automated agent 104 to the family member and to initiate an onboarding process for the family member and the family unit 112 itself.

The family-based wellness service 102 may be implemented to reduce the cognitive load of members and their families by identifying different family goals and generating tasks that may be performed by different family members and/or delegated to other entities (e.g., automated agents 104, human representatives associated with the family-based wellness service 102, third-party services, etc.) for performance on behalf of these families. For instance, as described in greater detail herein, if a family member associated with a family unit 112 expresses a desire for the family unit 112 to engage in more activities together (e.g., create a game night, devote a period of time each day to family communication, train for an event, etc.), the family-based wellness service 102 may automatically evaluate known attributes associated with the different family members 114-1-114-N of a family unit 112 to identify different tasks that may be performed by these family members 114-1-114-N to achieve this goal. Further, the family-based wellness service 102 may provide these family members 114-1-114-N with dynamic encouragement for completing these different tasks and achieving this goal.

In an embodiment, when a family member 114-1 associated with a family unit 112 accesses the family-based wellness service 102 for the first time, the family-based wellness service 102 may automatically assign an automated agent 104 to the family member 114-1 and initiate a new communications session between the family member 114-1 and the automated agent 104. The automated agent 104, in some instances, is dynamically trained to automatically identify and address user intents. Further, the automated agent 104 may be dynamically trained to prompt for and obtain different user attributes associated with different users (e.g., family member 114-1 and other family members 114-2-114-N associated with a family unit 112, etc.) in order to update corresponding user profiles and define relationships among these user profiles. As described in greater detail herein, these user profiles and corresponding relationships may be used to dynamically generate tasks that may be performed to achieve indicated family goals. The family-based wellness service 102 may further generate customized responses to these user intents according to any applicable constraints. These customized responses may be generated according to known responses maintained by the family-based wellness service 102 and/or to different data sources from which the family-based wellness service 102 may derive these customized responses according to the corresponding intents.

When a new communications session is established between a family member 114-1 and an automated agent 104, the automated agent 104 may automatically prompt the family member 114-1 to provide identifying information associated with the family member 114-1 and any other family members 114-2-114-N corresponding to the family unit 112. For instance, when the family member 114-1 first engages the automated agent 104 through a new communications session, the automated agent 104 may determine whether there is an existing relationship between the family member 114-1 and other users of the family-based wellness service 102. As an illustrative example, the automated agent 104 may prompt the family member 114-1 to provide detailed information with regard to the composition of the family member's family unit 112 (e.g., number of inhabitants in the member's home, the number of children in the member's home, the number and types of pets in the member's home, etc.), the physical location of the member's home, any special needs or requirements of the family member 114-1 and of any other family members 114-2-114-N associated with the family unit 112 (e.g., physical or emotional disabilities, etc.), and the like. In some instances, the family member 114-1 may be prompted to provide demographic information (e.g., age, ethnicity, race, languages written/spoken, etc.). The family member 114-1 may also be prompted to indicate any personal goals that may be used to identify possible projects and tasks that may be performed in order to achieve these goals, as described in greater detail herein.

In an embodiment, the family-based wellness service 102 provides an application or web service through which users (such as family member 114-1) may access an interface for initiating and engaging in communications sessions with automated agents 104 to address different user intents. For example, the family-based wellness service 102 may provide, to a family member 114-1, an application that may be installed and executed from the family member's computing device to access, through the interface, the family-based wellness service 102. Additionally, or alternatively, a family member 114-1, through a browser application installed and executed from the family member's computing device, may access a website associated with the family-based wellness service 102 and through which the family-based wellness service 102 implements a web service that includes the interface. In some instances, to access the interface (either through an application executing on a computing device or through a web service), the family member 114-1 may be required to provide a set of credentials (e.g., username/password, a cryptographic key or token, biometric information, etc.) that may be used to authenticate and identify the family member 114-1. For example, when the family member 114-1 executes the application or accesses the web service to initiate a new communications session through the family-based wellness service 102, the family-based wellness service 102 may prompt the family member 114-1 to provide a set of credentials associated with the family member 114-1.

In response to receiving the set of credentials associated with the family member 114-1, the family-based wellness service 102 may process the set of credentials to determine whether the set of credentials is valid. For instance, in response to receiving a set of credentials from a family member 114-1, the family-based wellness service 102 may query a user profile database 110 to determine whether the provided set of credentials is associated with an existing user profile maintained by the family-based wellness service 102. If the family-based wellness service 102 determines that the provided set of credentials is not associated with an existing user profile, or that the provided set of credentials is not valid (e.g., the set of credentials does not match a known set of credentials maintained in an identified user profile, the set of credentials is expired, the set of credentials are flagged as being compromised, etc.), the family-based wellness service 102 may reject the request from the family member 114-1 to initiate a communications session with an automated agent 104. If the family-based wellness service 102 determines that the set of credentials is valid or otherwise that the family member 114-1 has been successfully authenticated, the family-based wellness service 102 may establish a new communications session between the family member 114-1 and an automated agent 104.

In an embodiment, the family-based wellness service 102 implements a family profiling system 106 that automatically processes structured and unstructured data (e.g., communications shared through an ongoing communications session between a family member 114-1 and an automated agent 104, images, audio recordings, audiovisual recordings, documents, etc.), to identify different attributes of the family member 114-1 and any other family members 114-2-114-N associated with a family unit 112 and, accordingly, update corresponding user profiles to incorporate these attributes. The family profiling system 106 may comprise one or more computer systems of the family-based wellness service 102 or may be implemented as an application or process executing on a computer system of the family-based wellness service 102. In some instances, the family profiling system 106 may be configured with various special-purpose components that can facilitate real-time or near real-time processing of different structured and unstructured data from any number of different users (i.e., conversation data) as the structured and unstructured data is received.

In an embodiment, when a family member 114-1 initiates a communications session with an automated agent 104 for the first time (e.g., the family member 114-1 is new to the family-based wellness service 102), the automated agent 104 automatically initiates an onboarding process to obtain information associated with the family member 114-1 and with the family unit 112 that the family member 114-1 belongs to. For instance, when the communications session is initiated, the automated agent 104 may query the user profile database 110 to determine whether a user profile associated with the family member 114-1 or the family unit 112 is available. If the automated agent 104 determines that a user profile is not available for the family unit 112 and for the family member 114-1, the automated agent 104 may automatically prompt the family member 114-1 to provide information corresponding to the family member 114-1 and the family unit 112 itself. As an illustrative example, the automated agent 104 may prompt the family member 114-1 to indicate who are the other family members 114-2-114-N within the family unit 112. As another illustrative example, the automated agent 104 may prompt the family member 114-1 to indicate the relationship between these family members 114-2-114-N and the family member 114-1. In some instances, the automated agent 104 may prompt the family member 114-1 to upload any images, video recordings, audial recordings, or other media that may be processed to extract any unique characteristics associated with the family members 114-1-114-N within the family unit 112. For each uploaded media, the automated agent 104 may prompt the family member 114-1 to indicate which family members are associated with the uploaded media. For example, if the family member 114-1 uploads an image of a family member to the family-based wellness service 102, the automated agent 104 may prompt the family member 114-1 to indicate who is included in the image. Based on the family member's response, the automated agent 104 may associate the uploaded image with the corresponding family member included in the image.

In an embodiment, as the family member 114-1 submits a response to a prompt provided by the automated agent 104 (e.g., a communication, an image, a video recording, an audial recording, etc.), the response is automatically transmitted to the family profiling system 106 to dynamically extract any inferred preferences and/or attributes that may be used to define one or more profile attributes for the family member 114-1 and/or any other family member 114-2-114-N associated with the family unit 112. The family profiling system 106, in an embodiment, applies natural language processing (NLP) or any other language parsing algorithm or executable code to automatically parse the response. Through this parsing of the response, the family profiling system 106 may identify particular terms or phrases that may be used to determine different attributes associated with the family member 114-1, other family members 114-2-114-N, and/or the family unit 112 as a whole. As another illustrative example, if the family member 114-1 submits an image associated with a particular family member, the family profiling system 106 may apply a neural network (e.g., convolutional neural network (CNN) or other deep neural networks (DNNs)), geometric recognition algorithms, photometric recognition algorithms, principal component analysis using eigenfaces, linear discrimination analysis, elastic bunch graph matching using Fisherface algorithms, hidden Markov modeling, multilinear subspace learning using tensor representation, neuronal motivated dynamic link matching, support vector machines (SVMs), or any other suitable machine learning technique) to identify one or more characteristics (e.g., biometric signatures, etc.) associated with the particular family member. If the family member 114-1 submits an audial recording of a particular family member, the family profiling system 106 may process the audial recording through a computer audition model to determine a voice signature associated with the particular family member. The voice signature may correspond to different characteristics associated with the particular family member's voice that may be used to uniquely identify the particular family member based on their audial communications. As each family member may have a unique voice signature, the family profiling system 106 may be able to associate the particular family member with the identified voice signature determined through processing of the audial recording. This unique voice signature may be used by the family profiling system 106 (through the computer audition model) to automatically identify audial communications generated by the particular family member.

In an embodiment, the family profiling system 106 dynamically trains and implements one or more large language models (LLM) and/or other generative artificial intelligence processes to evaluate the extracted terms, phrases, or other characteristics from the provided response, identify one or more attributes that may be assigned to one or more user profile on the user profile database 110, and generate new messages and prompts for additional information according to the context of previously provided user responses. The one or more LLMs and/or other generative artificial intelligence processes implemented by the family profiling system 106 are, in an embodiment, dynamically trained using a dataset comprising a large corpus of sample communications/messages (e.g., historical communications/messages, hypothetical communications/messages, combinations of historical and hypothetical communications/messages, etc.), sample embeddings corresponding to the sample communications/messages, sample key-value pairs corresponding to inferred attributes and preferences included in the sample communications/messages and corresponding to the sample embeddings, and sample responses to the communications/messages. The one or more LLMs and/or other generative artificial intelligence processes may be initialized with a first set of values corresponding to different hyperparameters or other coefficients that, in combination, are used to derive an output given a sample input (e.g., sample communications/messages). For instance, the family profiling system 106 may initialize a set of coefficients or other hyperparameters randomly according to a Gaussian or non-Gaussian distribution. Using this initial iteration of the one or more LLMs or other generative artificial intelligence processes, the family profiling system 106 may process the dataset of sample communications/messages to generate an output. This output may specify, for each sample communication or message, one or more key-value pairs corresponding to inferred attributes and preferences and a response to the communication or message (e.g., an extracted attribute or preference, a message to be communicated, etc.). The one or more LLMs or other generative artificial intelligence processes may compare the output (e.g., predicted attribute or preference, response message to be communicated, etc.) to the expected responses included in the dataset. Based on this comparison, the one or more LLMs or other generative artificial intelligence processes may dynamically update the values corresponding to the different hyperparameters or other coefficients and again process the dataset to generate new outputs. This process may be repeated numerous times until an iteration of the one or more LLMs or other generative artificial intelligence processes is obtained that satisfies one or more accuracy or predictability thresholds.

In an embodiment, the one or more LLMs or other generative artificial intelligence processes are further trained to improve the predictability of the one or more LLMs or other generative artificial intelligence processes in accurately identifying and generating user attributes from received communications or messages. For instance, in addition to evaluating the one or more LLMs or other generative artificial intelligence processes according to linguistic metrics (e.g., Bilingual Evaluation Understudy (BLEU) scores, language fluency metrics, semantic consistency metrics, etc.), the family profiling system 106 may determine whether the one or more LLMs or other generative artificial intelligence processes are accurately leveraging available user profiles from the user profile database 110 and corresponding knowledge graphs to identify user attributes from the key-value pairs corresponding to the inferred preferences and attributes that may be associated with a user profile. For instance, the family profiling system 106 may evaluate the output generated by the one or more LLMs or other generative artificial intelligence processes to determine whether the one or more LLMs or other generative artificial intelligence processes are correctly converting the sample communications/messages into a set of embeddings and identifying appropriate key-value pairs of attributes that may be associated with a user profile according to this set of embeddings (e.g., correctly matching the set of embeddings to known attribute embeddings, etc.). Based on this evaluation, the family profiling system 106 may dynamically update the one or more LLMs or other generative artificial intelligence processes as described above to improve the identification of user attributes by these one or more LLMs or other generative artificial intelligence processes.

In response to a communication from the family member 114-1 to an automated agent 104, the family profiling system 106, through the one or more LLMs or other generative artificial intelligence processes, may dynamically extract one or more key-value pairs corresponding to inferred preferences and attributes from the communication and determine whether these one or more inferred preferences and attributes correspond to one or more profile attributes that may be added to a user profile associated with the family member 114-1 and/or other family members 114-2-114-N associated with the family unit 112. As an illustrative example, if the automated agent 104, through the communications session, prompts the family member 114-1 to indicate who are the other family members within the family unit 112, the family profiling system 106 may evaluate any responses associated with this prompt to determine (through the one or more LLMs or other generative artificial intelligence processes) whether these responses include information that may indicate the other family members within the family unit 112. For instance, if a response provided by the family member 114-1 includes one or more proper names (e.g., first names, etc.), the family profiling system 106, through the one or more LLMs or other generative artificial intelligence processes, may extract these one or more proper names and calculate an inference confidence score for each of the one or more proper names to determine whether these one or more proper names correspond to other family members within the family unit 112. As an illustrative example, if the family member 114-1 provides the response “We've got Miya and Maxine,” the family profiling system 106 may extract the terms “Miya” and Maxine” from the response and evaluate these terms against a knowledge graph of known proper names to calculate an inference confidence score for these terms.

The inference confidence score may denote a likelihood or confidence that the extracted term (or inferred preference or attribute) corresponds to an attribute that may be associated with a user and/or family profile. In some cases, the family profiling system 106 may establish a confidence threshold that may be used to determine whether an inferred preference or attribute extracted from a user response can be considered a profile attribute that may be added to a user profile and/or the family profile. For instance, if an inferred preference or attribute extracted from a response is assigned an inference confidence score that is below the confidence threshold, the family profiling system 106 may determine that the inferred preference or attribute has a low likelihood of being a profile attribute that may be incorporated into a user or family profile. Alternatively, if an inferred preference or attribute extracted from a response is assigned an inference confidence score that is equal to or greater than the confidence threshold, the family profiling system 106 may determine that the inferred preference or attribute corresponds to a profile attribute that should be added to a user and/or family profile. As described in greater detail herein, as user and family profiles are updated and as more inferred preferences or attributes are extracted from obtained communications, the family profiling system 106 may further incorporate existing user and family attributes and prior user and family attribute confirmations and/or denials to calculate inference confidence scores for newly obtained inferred preferences or attributes.

Based on the calculated inference confidence scores for these terms, the family profiling system 106 may determine that the terms “Miya” and “Maxine” are profile attributes that may be used to update user profiles in the user profile database 110. Further, as these terms may correspond to proper names associated with family members 114-2-114-N related to family member 114-1, the family profiling system 106 may query the user profile database 110 to determine whether there are any existing user profiles associated with these family members 114-2-114-N. If the family profiling system 106 determines that there are no existing profiles associated with the identified family members 114-2-114-N, the family profiling system 106 may dynamically generate new user profiles corresponding to these family members 114-2-114-N. Further, the family profiling system 106 may update these new user profiles to establish a relationship between these new user profiles and the user profile corresponding to family member 114-1. This may result in an establishment of a family unit relationship among the family members 114-1-114-N within the user profile database 110. If the family profiling system 106 determines that there are existing profiles associated with the identified family members 114-2-114-N, the family profiling system 106 may update these existing user profiles to associate these user profiles with the user profile of family member 114-1 to establish the family unit relationship within the user profile database 110.

In an embodiment, the family profiling system 106, through the one or more LLMs or other generative artificial intelligence processes, further evaluates the user profiles corresponding to the family members 114-1-114-N of the family unit 112 and the previous communications exchanged during the ongoing communications session between the family member 114-1 and an automated agent 104 to generate new communications that may be exchanged with the family member 114-1 to obtain additional profile attributes for these user profiles. For instance, based on these previous communications, the family profiling system 106 (through the one or more LLMs or other generative artificial intelligence processes) may dynamically determine the context of the ongoing communications session and provide to the automated agent 104 a response that is relevant to the ongoing communications session and is responsive to the family member's communications. As an illustrative example, if a family member 114-1 provides the names of the other family members 114-2-114-N within the family unit 112, the family profiling system 106 (through the one or more LLMs or other generative artificial intelligence processes) may determine that the automated agent 104 should prompt the family member 114-1 to indicate each other family member's relationship to the family member 114-1. Accordingly, the family profiling system 106 may generate a response that prompts the family member 114-1 to indicate these other family members'relationships to the family member 114-1. The automated agent 104 may subsequently present this response to the family member 114-1 through the ongoing communications session. As another illustrative example, the family profiling system 106 may determine that the automated agent 104 should prompt the family member 114-1 to provide an image, video recording, audial recording, or other available media corresponding to the other family members 114-2-114-N in order to identify additional profile attributes associated with these other family members 114-2-114-N. The automated agent 104 may subsequently prompt the family member 114-1 to upload an image, video recording, audial recording, or other available media that may be processed to extract any unique attributes that may be associated with other family members 114-2-114-N.

As the family members 114-1-114-N associated with the family unit 112 communicate with automated agents 104 implemented by the family-based wellness service 102, the family profiling system 106 may dynamically process any exchanged communications and uploaded media in real-time to extract any inferred preferences and attributes. Further, the family profiling system 106, through the one or more LLMs or other generative artificial intelligence processes, may evaluate these inferred preferences and attributes according to any available user and family profile data corresponding to these family members 114-1-114-N to identify any user and family attributes that may be added to the user profiles and the family profile corresponding to these family members 114-1-114-N.

In an embodiment, the family profiling system 106 further processes conversation data and any exchanged media (e.g., images, audial recordings, video recordings, etc.) corresponding to communications among the different family members 114-1-114-N to obtain additional inferred preferences and attributes that may be evaluated to identify new user and family attributes that may be assigned to these family members 114-1-114-N and to the family unit 112 as a whole. For instance, the family-based wellness service 102 may facilitate communications sessions among family members 114-1-114-N and that may include one or more automated agents 104 that may assist these family members 114-1-114-N with different tasks, goals, and/or any other issue. Through these communications sessions, family members 114-1-114-N may communicate with one another without automated agent intervention. As an illustrative example, through an ongoing communications session, a family member 114-1 may ask a different family member 114-2 whether they have completed a particular chore within the family home (e.g., taking out the garbage, doing the dishes, cleaning the bathroom, etc.). The family profiling system 106, through the one or more LLMs or other generative artificial intelligence processes, may additionally process these communications among different family members 114-1-114-N to extract any additional inferred preferences and attributes and, based on evaluation of these additional inferred preferences and attributes and existing user profiles for the family members 114-1-114-N, identify and/or update any profile attributes for these existing user profiles. As another illustrative example, through an ongoing communications session, a family member 114-1 may exchange a picture of the family member 114-1 to a different family member 114-2. The family profiling system 106, through the one or more LLMs or other generative artificial intelligence processes, may process this exchanged image and extract any additional biometric information associated with the family member 114-1, as well as any additional inferred preferences and attributes based on elements included in the image (e.g., emotional expressions, preferred locations and/or activities, etc.).

In addition to processing structured and unstructured data from ongoing communications sessions, the family profiling system 106, in an embodiment, further processes family member interactions with one or more third-party data sources 116 to obtain additional information that may be used to define user and family attributes for corresponding user and family profiles, respectively. For instance, when the family members 114-1-114-N access the family-based wellness service 102 for the first time, the family-based wellness service 102 may prompt these family members 114-1-114-N to authorize the family-based wellness service 102 to access these third-party data sources 116 to obtain additional data that may be used to enhance these family members'user profiles and the family profile corresponding to the family unit 112. Third-party data sources 116 may include, but are not limited to, social media platforms, electronic mail services, calendaring services, personal fitness devices (e.g., fitness trackers, exercise equipment having communication capabilities, etc.), and the like. The data from these third-party data sources 116 may further indicate different interactions among the family members 114-1-114-N and other information that may be used to further determine the family dynamics and identify additional user attributes that may be incorporated into the user profiles associated with these family members 114-1-114-N. Data from these third-party data sources 116 may include structured and unstructured data, which may be processed by the family profiling system 106 to extract any user and family attributes.

It should be noted that the family profiling system 106 continuously, and in real-time, processes structured and unstructured data from different ongoing communications sessions (including ongoing communications sessions between family members 114-1-114-N and one or more automated agents 104 and ongoing communications sessions among these family members 114-1-114-N) and from the third-party data sources 116 to continuously update and refine the user profiles associated with the family members 114-1-114-N and the family profile associated with the family unit 112. This may ensure that the user profiles and the family profile accurately convey the unique attributes of each family member 114-1-114-N within the family unit 112 and of the family unit 112 itself. Further, this may ensure that the relationships between these family members 114-1-114-N as defined through the user profiles closely mirror the unique dynamics of the family unit 112. This may allow the family profiling system 106, through the automated agents 104, to better communicate with the different family members 114-1-114-N according to their unique attributes and according to the identified dynamics of the family unit 112.

The family profiling system 106, through the continuous processing of this structured and unstructured data from different ongoing communications sessions and from the third-party data sources 116, further improves the functionality of the various systems and processes of the family-based wellness service 102. For example, by dynamically updating and refining the user profiles and the family profile associated with the family members 114-1-114-N as these family members 114-1-114-N engage in different ongoing communications sessions and with third-party data sources 116, the number of prompts provided by automated agents 104 to these family members 114-1-114-N may be reduced, as these automated agents 104 may no longer be required to directly prompt these family members 114-1-114-N for information corresponding to the unique dynamics of the family unit 112 and to the unique attributes of each of the family members 114-1-114-N. By reducing the number of prompts required to obtain this data, the processing requirements of the family-based wellness service 102 are reduced, thereby improving the efficiency of the various systems and processes of the family-based wellness service 102.

In an embodiment, the family-based wellness service 102 further implements a task recommendation system 108 that dynamically generates and provides recommendations for different tasks and projects that the family unit 112 may engage in according to indicated goals. The task recommendation system 108 may be implemented using a computer system or as an application or other executable code implemented on a computer system of the family-based wellness service 102. In an embodiment, the task recommendation system 108 is configured to dynamically process structured and unstructured data corresponding to real-time communications exchanged between different family members 114-1-114-N and one or more automated agents 104 through ongoing communications sessions to dynamically identify one or more goals that the family unit 112 would like to achieve. For instance, the task recommendation system 108, using NLP or other language processing algorithm in conjunction with one or more LLMs or other generative artificial intelligence processes, may dynamically evaluate structured and unstructured data corresponding to ongoing communications sessions between different family members 114-1-114-N of a family unit 112 and one or more automated agents 104 to identify a goal that the family unit 112 wishes to achieve and for which the family-based wellness service 102 may be used to identify possible tasks that may be performed to achieve the goal.

In an embodiment, the task recommendation system 108 implements and dynamically trains a machine learning algorithm or artificial intelligence to automatically generate a set of tasks that can be performed by the family members 114-1-114-N of the family unit 112 to achieve the identified goal. The machine learning algorithm or artificial intelligence utilized by the task recommendation system 108 to automatically, and dynamically, generate a set of tasks for accomplishing an identified goal may be trained using supervised training techniques. For instance, the machine learning algorithm or artificial intelligence may be trained using a dataset of sample goals, sample user profiles corresponding to different family units, and expected tasks performable to achieve the sample goals. The machine learning algorithm or artificial intelligence can be evaluated to determine, based on the sample inputs supplied to the machine learning algorithm or artificial intelligence from the dataset, whether the machine learning algorithm or artificial intelligence is producing a set of tasks that is conducive to achieving a corresponding sample goal. Based on this evaluation, the machine learning algorithm or artificial intelligence may be modified to increase the likelihood of the machine learning algorithm or artificial intelligence generating the desired results. The machine learning algorithm or artificial intelligence may further be dynamically trained by soliciting feedback from family members 114-1-114-N with regard to the tasks provided by the machine learning algorithm or artificial intelligence for given goals. For instance, the task recommendation system 108 may obtain new feedback from the family members 114-1-114-N after performance of a set of tasks generated by the task recommendation system 108 corresponding to a particular goal. The machine learning algorithm or artificial intelligence may use this feedback to determine whether the set of tasks were conducive to the family members 114-1-114-N achieving their goal. This determination may be used to further train the machine learning algorithm or artificial intelligence to provide better tasks that may be performed to achieve similar goals.

Through the machine learning algorithm or artificial intelligence, the task recommendation system 108 may dynamically process the structured and unstructured data corresponding to the one or more ongoing communications sessions and the user profiles corresponding to the family members 114-1-114-N to identify a goal that the family unit 112 would like to achieve and one or more tasks that may be performed by the family members 114-1-114-N to achieve the goal. The one or more tasks may be assigned to different family members 114-1-114-N according to the user attributes associated with each of the different family members 114-1-114-N. For example, if the family unit 112 has expressed a goal to spend at least one-hundred and fifty minutes of active time together per week, the task recommendation system 108 may evaluate the user profiles corresponding to the family members 114-1-114-N and the family profile corresponding to the family unit 112 to identify any current tasks associated with these family members 114-1-114-N that may impede the family unit's ability to achieve this goal. Additionally, the task recommendation system 108 may evaluate these user profiles to identify each family member's role within the family unit 112, which may inform what tasks may be assigned to each family member 114-1-114-N in order to achieve the goal. In some instances, the task recommendation system 108 may further identify, based on the user profiles, different family member idiosyncrasies that may inform the task recommendation system 108 as to how to encourage the different family members 114-1-114-N to perform the assigned tasks and achieve the goal. For example, if a particular family member is motivated by competition with other family members, the task recommendation system 108 may determine that this particular family member should be provided with routine updates with regard to the performance of tasks assigned to these other family members. As another illustrative example, if a particular family member is known to procrastinate when it comes to completing tasks, the task recommendation system 108 may determine that this particular family member should be provided with routine reminders (e.g., notifications, alarms, motivating messages, etc.) to complete their assigned tasks.

In an embodiment, the task recommendation system 108 can provide the goal and the assigned tasks to the one or more automated agents 104 engaged in one or more ongoing communications sessions with the family members 114-1-114-N to communicate the goal and the assigned tasks to the family members 114-1-114-N. These one or more automated agents 104, through the one or more ongoing communications sessions, may present the goal and the tasks assigned to each family member 114-1-114-N. Further, based on the identified idiosyncrasies associated with each family member 114-1-114-N, the automated agents 104 may provide tailored communications and interfaces through which a family member may be presented with individualized motivators (e.g., graphics, messages, statistics, reminders, etc.) that may be implemented to encourage the family member to achieve their assigned tasks.

Thus, the family profiling system 106 further provides additional benefits that may improve the functionality of the task recommendation system 108 and of the automated agents 104. For instance, because the family profiling system 106, through the continuous processing of this structured and unstructured data from different ongoing communications sessions and from the third-party data sources 116, dynamically updates and refines the user profiles and the family profile associated with the family members 114-1-114-N as these family members 114-1-114-N engage in different ongoing communications sessions and with third-party data sources 116, the task recommendation system 108 may be more likely to identify family-based goals and corresponding tasks that comport with each family member's idiosyncrasies. Furthermore, because the task recommendation system 108 leverages the family and user profiles dynamically updated and refined by the family profiling system 106 in real-time, the need to prompt one or more family members 114-1-114-N for additional data usable for defining these tasks may be drastically reduced. This may result in additional reduction in the resources required by the family-based wellness service 102 (e.g., memory, processing, network bandwidth, etc.) to identify family-based goals and to define corresponding tasks for achieving these goals.

In an embodiment, the task recommendation system 108 dynamically monitors performance of the family members 114-1-114-N for completion of their assigned tasks and to track the family unit 112 progression towards the specified goal. In some instances, a particular task that is to be performed by one or more family members 114-1-114-N of the family unit 112 may be subject to a deadline or other temporal limit. For example, if a particular goal is to be accomplished within a pre-defined timeframe, each task assigned to the one or more family members 114-1-114-N of the family unit 112 may need to be performed according to their respective deadlines or other temporal limits in order to ensure that the requisite progress is being made towards achieving the stated goal. Accordingly, the task recommendation system 108 may, in real-time, process any structured and unstructured data exchanged between the different family members 114-1-114-N and the one or more automated agents 104 through the ongoing communications sessions (e.g., communications sessions specific to the assigned tasks, communications sessions associated with the goal, etc.) to determine whether the assigned tasks associated with the goal have been performed or are in the process of being performed.

If a task associated with the stated goal has been completed, the task recommendation system 108 may indicate, via interfaces provided to the family members 114-1-114-N (e.g., graphical user interfaces provided through applications installed on family unit computing devices, interfaces provided through a web service, etc.), that the task has been completed. Further, the task recommendation system 108 may update these interfaces to provide an indication of how the family unit 112 is progressing towards achieving the stated goal. In some instances, the task recommendation system 108 may update these interfaces to provide a graphical indication that the task has been completed. For example, the task recommendation system 108 may move the completed task to a section of the interfaces corresponding to completed tasks (e.g., a “Completed To-Dos” section of the interfaces, etc.). This process may continue until the tasks associated with the stated goal are completed and the stated goal is presumed achieved.

In an embodiment, the task recommendation system 108 can detect when one or more tasks assigned to the family members 114-1-114-N have not been completed within their respective deadlines or other temporal limits and accordingly perform one or more actions to motive the family members 114-1-114-N to complete these one or more tasks. As noted above, the task recommendation system 108 may monitor the performance of tasks associated with a stated goal in real-time. This may include processing structured and unstructured data exchanged between each family member 114-1-114-N and automated agents 104 as structured and unstructured data is exchanged over the communications sessions associated with each of these tasks. The task recommendation system 108 may utilize a machine learning algorithm or artificial intelligence (e.g., NLP) to process the structured and unstructured data in real-time and determine the status of each task assigned to the family members 114-1-114-N. For example, if a family member indicates, in a message to an automated agent 104 through a communications session corresponding to a task assigned to the family member, that they are unable to perform the assigned task within the time allotted for the task, the task recommendation system 108 may determine that the assigned task will not be completed within the time allotted for the task. As another example, the task recommendation system 108 may determine that no action or information corresponding to performance of the task has been received at the end of the time allotted for the task. This may cause the task recommendation system 108 to prompt the automated agent 104 to communicate with the family member to determine whether the task has been completed. If the family member indicates that the task has not been completed, the task recommendation system 108 may record the task as not having been completed within the allotted time for the task.

In some instances, if the task recommendation system 108 detects that a task assigned to a particular family member of the family unit 112 has not been completed within the allotted time frame, the task recommendation system 108 may automatically process the family member's user profile from the user profile database 110 to identify one or more actions that may be performed to motivate the family member to complete the assigned task. As noted above, the task recommendation system 108 may identify, based on the user profiles, different family member idiosyncrasies that may inform the task recommendation system 108 as to how to encourage the different family members 114-1-114-N to perform the assigned tasks and achieve the goal. Based on this evaluation of the family member's user profile, the other user profiles associated with the other family members of the family unit 112, and the family profile associated with the family unit 112, the task recommendation system 108 may dynamically identify an action that may be performed by the task recommendation system 108 and/or an automated agent 104 to motivate the family member to complete the task. As an illustrative example, if the family member is motivated by routine notifications or alarms that may serve to remind the family member of tasks that need to be completed, the task recommendation system 108 may update the interface provided by the family-based wellness service 102 to this family member to provide a notification or alert that the task has not been completed. As another illustrative example, if the family member is motivated by competition with other family members of the family unit, the task recommendation system 108 may update the interface to indicate how other family members are completing their assigned tasks. Further, the task recommendation system 108, through one or more automated agents 104, may transmit a notification to these other family members to indicate that the family member has not completed their assigned task.

In an embodiment, the task recommendation system 108 can prompt the family members 114-1-114-N to upload or otherwise provide images, video recordings, audial recordings, and the like to the task recommendation system 108 as part of their assigned tasks. For example, if one or more family members are assigned a task to complete one or more hikes within the North Cascades National Park, the task recommendation system 108 may prompt these one or more family members to upload pictures of their hiking activities within the North Cascades National Park in order to demonstrate that these hikes have been completed. As another illustrative example, the task recommendation system 108 may prompt the one or more family members to upload a recording of these one or more family members reaching the end of the Sahale Arm Trail, indicating their emotions upon having achieved the end of their journey.

As noted above, the task recommendation system 108 may provide the family members 114-1-114-N motivators for completing their assigned tasks or a collective goal. For instance, the task recommendation system 108 may gamify these assigned tasks or collective goal by awarding experience points, badges, and the like to family members for performing different actions. Returning to the earlier illustrative example associated with hiking activities within the North Cascades National Park, a family member that uploads an image or other recording associated with an assigned hike may be awarded with a set number of experience points. Each family member 114-1-114-N, through their respective version of the application installed on their family unit computing devices, may receive a notification or other indication of the awarding of experience points to the family member that uploaded the image or other recording. This may serve as a motivator to the other family members to upload their own images or other recordings associated with the assigned hike in order to earn their own experience points.

In an embodiment, the task recommendation system 108, through the family profiling system 106, dynamically processes any uploaded images or other recordings provided by the family members 114-1-114-N through one or more LLMs, computer vision models, computer audition models, or other machine learning/artificial intelligence processes to analyze and extract any potential idiosyncrasies or other unique characteristics of each of the family members or of the family unit as a whole. For instance, the task recommendation system 108 may transmit an uploaded image or video recording to the family profiling system 106 to identify (using a neural network, as noted above) one or more characteristic representations of one or more family members from the uploaded image or video recording. As another illustrative example, if a family member uploads an audial recording to the task recommendation system 108, the family profiling system 106 may dynamically process the audial recording through one or more computer audition models to identify any voice signatures associated with any of the family members 114-1-114-N. A voice signature may correspond to different characteristics associated with a family member's voice that may be used to uniquely identify the family member based on their audial communications. As each family member may have a unique voice signature, the task recommendation system 108 may be able to associate a family member with a voice signature determined through processing of the audial recording.

In an embodiment, the task recommendation system 108 can collect structured and unstructured data from personal fitness devices and other sources to determine whether an assigned task has been completed. A family member associated with an assigned task may provide the family-based wellness service 102 with access to these one or more member resources, whereby the task recommendation system 108 may periodically or at particular times access these member resources to obtain task-related data that may be used to determine whether tasks assigned to the family member are being completed according to the allotted times for completion of these tasks. As an illustrative example, if a particular task involves having the family member perform interval training followed by a one-mile run by a given time, the task recommendation system 108 can obtain data from one or more fitness devices associated with the family member's user profile. The data may include Global Positioning System (GPS) data, steps data, heart rate readings, blood pressure readings, PaO2 readings, and the like. Using this data, the task recommendation system 108 may automatically determine if the family member has completed the particular task. The task recommendation system 108, in some instances, may also prompt the automated agent 104 associated with the assigned task to communicate with the family member with regard to these readings to determine whether the assigned task has been completed. For example, if the GPS data for the family member indicates that the family member may have run a mile during the allotted time for the assigned task, the automated agent 104 may transmit a message to family member over the communications session corresponding to the particular task to prompt the family member to indicate whether the particular task has been completed.

The task recommendation system 108 may continue to monitor performance of the tasks associated with the stated goal to determine whether the stated goal has been achieved. For instance, as the family members 114-1-114-N complete their assigned tasks associated with the stated goal, the task recommendation system 108 may automatically, and in real-time, record the progress towards achieving the stated goal. Additionally, the task recommendation system 108 may monitor and process structured and unstructured data (e.g., messages, images, recordings, etc.) among the family members 114-1-114-N and the automated agents 104 (e.g., communications sessions associated with assigned tasks, communications sessions through which family members 114-1-114-N communicate with one another, etc.) in real-time and as structured and unstructured data is exchanged to determine the progress towards achieving the stated goal. This new structured and unstructured data may serve as feedback with regard to each performed task and to the overall structure of the set of tasks for achieving the stated goal. Further, once the set of tasks corresponding to the stated goal have been completed, the task recommendation system 108 may prompt the family members 114-1-114-N for feedback with regard to the set of tasks and as to whether the stated goal was achieved as a result of performance of the set of tasks. If the family members 114-1-114-N indicate that the set of tasks helped the family unit 112 achieve the stated goal, the task recommendation system 108 may assign a positive polarity to the set of tasks and the timeframe utilized for achieving the stated goal. Alternatively, if the family members 114-1-114-N indicate that the set of tasks were unfavorable and/or that performance of the set of tasks did not result in the family unit 112 achieving the stated goal, the task recommendation system 108 may assign a negative polarity to the set of tasks and timeframe utilized for achieving the stated goal. The obtained feedback, in an embodiment, can be used to update or retrain the machine learning algorithm or artificial intelligence utilized by the task recommendation system 108 to generate different tasks that may be performed to achieve similar goals for similarly situated family units.

In some instances, the task recommendation system 108 may dynamically update the goal and/or any tasks assigned to the different family members 114-1-114-N in real-time as the user profiles associated with the family members 114-1-114-N are dynamically updated through real-time and continuous processing of structured and unstructured data from different ongoing communications sessions and from the third-party data sources 116. For example, as the family profiling system 106 updates the user profiles through the continuous process of structured and unstructured data, the task recommendation system 108 may dynamically process the previously identified goal and corresponding tasks through the aforementioned machine learning algorithm or artificial intelligence to determine whether any changes to the goal and/or any of the corresponding tasks should be implemented to improve the likelihood of the goal being achieved. If the task recommendation system 108 identifies one or more changes to the goal and/or the corresponding tasks that should be implemented for the family unit 112, the task recommendation system 108 may communicate these changes to the different family members 114-1-114-N through the aforementioned automated agents 104. Additionally, based on these updated profiles, the changes may be communicated according to each family member's idiosyncrasies.

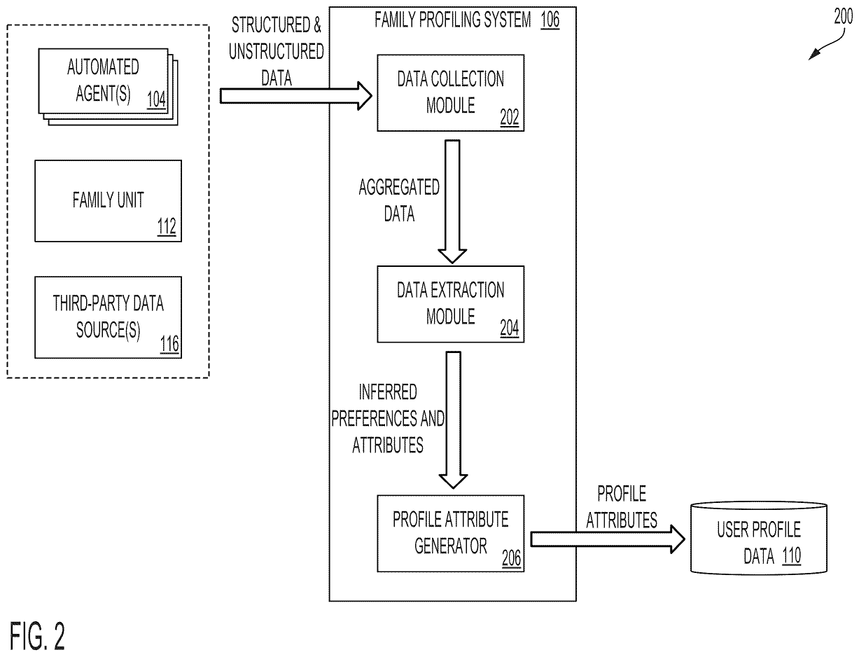

FIG. 2 shows an illustrative example of an environment 200 in which a family profiling system 106 dynamically processes structured and unstructured data from different data sources to extract inferred user preferences and attributes for updating different family-based user profiles and to further define relationships among the family-based user profiles in accordance with at least one embodiment. In the environment 200, the family profiling system 106 implements a data collection module 202 that is configured to obtain, in real-time, structured and unstructured data from automated agents 104, a family unit 112, and third-party data sources 116 associated with the family unit 112. The data collection module 202 may be implemented using a computer system or as an application or other executable code implemented on a computer system of the family profiling system 106.

As noted above, when a family member associated with a family unit 112 accesses the family-based wellness service for the first time, the family-based wellness service may automatically assign an automated agent 104 to the family member and initiate a new communications session between the family member and the automated agent 104. When a new communications session is established between a family member and an automated agent 104, the automated agent 104 may automatically prompt the family member to provide identifying information associated with the family member and any other family members corresponding to the family unit 112. For instance, when the family member first engages the automated agent 104 through a new communications session, the automated agent 104 may determine whether there is an existing relationship between the family member and other users of the family-based wellness service. Returning to an earlier illustrative example, the automated agent 104 may prompt the family member to provide detailed information with regard to the composition of the family member's family unit 112 (e.g., number of inhabitants in the member's home, the number of children in the member's home, the number and types of pets in the member's home, etc.), the physical location of the member's home, any special needs or requirements of the family member and of any other family members associated with the family unit 112 (e.g., physical or emotional disabilities, etc.), and the like. In some instances, the family member may be prompted to provide demographic information (e.g., age, ethnicity, race, languages written/spoken, etc.) associated with the family member and any other family members associated with the family unit 112. The family member may also be prompted to indicate any personal goals that may be used to identify possible tasks that may be performed in order to achieve these goals. In some instances, the family member may be prompted to upload any images, recordings, or other media associated with the family member and any other family members associated with the family unit 112. These images, recordings, or other media may be processed to extract any biometric information or other attributes associated with the family member and any other family members.

In an embodiment, the family-based wellness service further implements different communications sessions between different automated agents 104 and different family members of a family unit 112. This allows the family-based wellness service, through the different communications sessions and different automated agents 104, to have tailored communications with different family members of the family unit 112 according to the idiosyncrasies of each of these different family members. For instance, when a first family member associated with a family unit 112 accesses the family-based wellness service and initiates a communications session with an automated agent 104, the family member may provide information corresponding to other family members associated with the family unit 112. Using this information, the family-based wellness service may transmit a notification (such as through an electronic mail message, text message, etc.) to these other family members to invite these family members to access the family-based wellness service. If another family member accesses the family-based wellness service in response to this notification, the family-based wellness service may facilitate a new communications session between this other family member and an automated agent 104 (e.g., the same automated agent as the one communicating with the first family member, a different automated agent, etc.). Further, the family-based wellness service may allow this other family member to communicate with the first family member through an existing communications session and/or through a new communications session. In an embodiment, as family members associated with the family unit 112 communicate with different automated agents 104 through different ongoing communications sessions, the data collection module 202 may obtain, in real-time, any communications and other structured and unstructured data exchanged between these family members and the different automated agents 104. For instance, as family members submit responses to prompts provided by automated agents 104 through these ongoing communications sessions, these responses are automatically transmitted to the data collection module 202.

The data collection module 202 may further obtain structured and unstructured data from the family members associated with the family unit 112 directly. As noted above, the family-based wellness service may facilitate communications sessions among the different family members of a family unit 112 to allow these family members to communicate amongst themselves without automated agent intervention. Returning to an earlier illustrative example, through an ongoing communications session, a family member may ask a different family member whether they have completed a particular chore within the family home (e.g., taking out the garbage, doing the dishes, cleaning the bathroom, etc.). The data collection module 202 may automatically monitor these communications sessions and obtain, in real-time, any communications exchanged among these family members. As another illustrative example, through an ongoing communications session, a family member may share an image or recording that may be associated with the family member and/or other family members of the family unit 112. The data collection module 202 may automatically obtain this image or recording for further processing.

The data collection module 202 may further process family member interactions with one or more third-party data sources 116 to obtain additional information that may be used to define user attributes for corresponding user profiles. As noted above, when the family members access the family-based wellness service for the first time, the family-based wellness service may prompt these family members to authorize the family-based wellness service to access these third-party data sources 116 to obtain additional structured and unstructured data that may be used to enhance these family members'user profiles. The structured and unstructured data from these third-party data sources 116 may further indicate different interactions among the family members and other information that may be used to further determine the family dynamics and identify additional user attributes that may be incorporated into the user profiles associated with these family members and the family unit 112.

In an embodiment, the data collection module 202 applies NLP or any other language parsing algorithm or executable code to automatically parse any communications exchanged amongst the family members of the family unit 112 and any communications exchanged between family members and automated agents 104. Through this parsing of obtained communications, the data collection module 202 may dynamically identify different terms and phrases expressed by different family members that may be used to identify different attributes associated with these family members and with the family unit 112 as a whole. The NLP may be dynamically trained using a dataset of sample communications/messages (e.g., historical communications/messages, hypothetical communications/messages, combinations of historical and hypothetical communications/messages, etc.) and sample embeddings corresponding to the sample communications/messages. To dynamically train the NLP, the family profiling system 106 may generate an initial iteration of the NLP. For instance, the family profiling system 106 may initialize a set of coefficients or hyperparameters randomly according to a Gaussian distribution with low variance centered around zero. Using this initial iteration of the NLP, the family profiling system 106 may process the dataset of sample communications/messages and corresponding embeddings to generate an output. This output may specify, for each sample communication/message included in the dataset, a predicted set of embeddings. The family profiling system 106 may compare the predicted set of embeddings generated using the initial iteration of the NLP to the sample embeddings defined in the dataset for each of the data points (e.g., sample communications/messages) to identify any inaccuracies or other errors.

If the output of the NLP does not satisfy one or more criteria, the family profiling system 106 may iteratively update one or more coefficients of the set of coefficients to generate a new iteration of the NLP. This new iteration of the NLP may be used to process the aforementioned training dataset, as well as any additional data points or other datasets obtained by the family-based wellness service to generate a new output for each data point in the training dataset. In some instances, the family profiling system 106 may use an optimization algorithm to iteratively update the one or more coefficients of the set of coefficients associated with the NLP. The family profiling system 106 may use this new iteration of the NLP to process the available data points and generate a new output. The family profiling system 106 may evaluate this new output to determine whether the output satisfies the one or more criteria. This process of updating the set of coefficients associated with the NLP according to the one or more criteria may be performed iteratively until an iteration of the NLP is produced that satisfies the one or more criteria. Thus, using NLP or other any other language parsing algorithm or executable code, the data collection module 202 may dynamically convert obtained communications into different embeddings that may correspond to different inferred attributes and preferences that may be associated with different family members of the family unit 112.

In an embodiment, the data collection module 202 further applies one or more LLMs, computer vision models, computer audition models, or other machine learning/artificial intelligence processes to automatically process any images, recordings, and/or other media exchanged amongst the family members of the family unit 112 and exchanged between family members and automated agents 104. For instance, if a family member submits an image associated with a particular family member, the data collection module 202 may apply a neural network to identify one or more characteristics (e.g., biometric signatures, etc.) associated with the particular family member. If the family member submits an audial recording of a particular family member, the data collection module 202 may process the audial recording through a computer audition model to determine a voice signature associated with the particular family member. The identified one or more characteristics associated with a particular family member may be processed by one or more LLMs and/or other generative artificial intelligence processes implemented by the data extraction module 204 to identify any inferred preferences and attributes associated with the particular family member, as described in greater detail herein. As feedback is obtained with regard to these inferred preferences and attributes, the one or more LLMs, computer vision models, computer audition models, or other machine learning/artificial intelligence processes implemented by the data collection module 202 may be updated to improve the accuracy in identifying family member preferences and attributes from different media sources.

In an embodiment, as the data collection module 202 collects structured and unstructured data from the different data sources described above (i.e., automated agents 104, the family unit 112 itself, and the third-party data sources 116), the data collection module may aggregate this structured and unstructured data and provide the aggregated data to a data extraction module 204 of the family profiling system 106 for further processing. The data extraction module 204 may be implemented using a computer system or as an application or other executable code implemented on a computer system of the family profiling system 106. The data extraction module 204, in an embodiment, dynamically trains and implements one or more LLMs and/or other generative artificial intelligence processes to evaluate aggregated structured and unstructured data from the data collection module 202 to identify one or more inferred preferences and attributes that may be associated with the family members of the family unit 112. These one or more LLMs and/or other generative artificial intelligence processes may be dynamically trained using a dataset comprising a large corpus of sample data (e.g., historical data and corresponding embeddings, hypothetical data and corresponding embeddings, combinations of historical data and corresponding embeddings, etc.) and sample key-value pairs corresponding to inferred attributes and preferences corresponding to the sample embeddings. The one or more LLMs and/or other generative artificial intelligence processes may be initialized with a first set of values corresponding to different hyperparameters or other coefficients that, in combination, are used to derive an output given a sample input (e.g., sample data). For instance, the family profiling system 106 may initialize a set of coefficients or other hyperparameters randomly according to a Gaussian or non-Gaussian distribution. Using this initial iteration of the one or more LLMs or other generative artificial intelligence processes, the family profiling system 106 may process the dataset of sample data to generate an output. This output may specify, for each sample data point (e.g., sample embeddings corresponding to one or more sample communications, sample images, sample recordings, etc.), one or more key-value pairs corresponding to inferred attributes and preferences. The one or more LLMs or other generative artificial intelligence processes may compare the output (e.g., predicted inferred attribute or preference, etc.) to the expected key-value pair included in the dataset. Based on this comparison, the one or more LLMs or other generative artificial intelligence processes may dynamically update the values corresponding to the different hyperparameters or other coefficients and again process the dataset to generate new outputs. This process may be repeated numerous times until an iteration of the one or more LLMs or other generative artificial intelligence processes is obtained that satisfies one or more accuracy or predictability thresholds.

In an embodiment, the one or more LLMs or other generative artificial intelligence processes implemented by the data extraction module 204 may further calculate an inference confidence score for each inferred preference and attribute generated based on the obtained data. As noted above, an inference confidence score may denote a likelihood or confidence that the extracted term (or inferred preference or attribute) corresponds to an attribute that may be associated with a user or family profile. An inference confidence score may be calculated using named entity recognition (NER) tagging, joint entity recognition and disambiguation (JERL), or other NLP-based process. For example, the data extraction module 204 may process the obtained data using the one or more LLMs or other generative artificial intelligence processes and a selected NLP-based process (e.g., NER, JERL, etc.) to generate key-value pairs corresponding to different inferred attributes and preferences. Each of these key-value pairs may be designated as a tag. Further, for each of these tags, the one or more LLMs or other generative artificial intelligence processes may assign a confidence score, whereby a higher confidence score denotes a greater confidence in the accuracy of the tag identification performed using selected NLP-based process. The determination of confidence scores may be tuned over time, as additional data points (e.g., communications and key-value pairs/tags) are obtained and used to train the one or more LLMs or other generative artificial intelligence processes. For example, tags and corresponding confidence scores, as well as the original communications and other data obtained from the aforementioned data sources, may be evaluated to determine whether the one or more LLMs or other generative artificial intelligence processes are accurately assigning tags to the embeddings provided by the data collection module 202. For example, if the one or more LLMs or other generative artificial intelligence processes assigns a high confidence score to a key-value pair corresponding to a particular inferred preference or attribute that has been assigned to one or more data points, and the key-value pair does not actually correspond to the one or more data points, the one or more LLMs or other generative artificial intelligence processes may be retrained to reduce the likelihood (e.g., confidence score) for similar classifications of data.

As the data extraction module 204, through the aforementioned LLMs or other generative artificial intelligence processes, generates new inferred preferences and attributes from the obtained data, the data extraction module 204 may provide these new inferred preferences and attributes, as well as corresponding inference confidence scores, to a profile attribute generator 206 of the family profiling system 106 to identify any profile attributes associated with different family members and/or the family unit 112 that may be incorporated into corresponding profiles in the user profile database 110. The profile attribute generator 206 may be implemented using a computer system or as an application or other executable code implemented on a computer system of the family profiling system 106.

In an embodiment, the profile attribute generator 206 implements and dynamically trains one or more LLMs or other generative artificial intelligence processes to evaluate inferred attributes and preferences generated by the data extraction module 204 against existing attributes indicated in existing user and family unit profiles to determine whether to merge these inferred attributed and preferences with these existing attributes. The profile attribute generator 206, as described in greater detail herein, may access a knowledge graph and vector store within the user profile database 110 to perform a semantic similarity process through the one or more LLMs or other generative artificial intelligence processes and map the inferred attributes and preferences to known attributes that may be defined in user and family unit profiles. Accordingly, the one or more LLMs or other generative artificial intelligence processes may convert the inferred preferences and attributes into proposed user attributes that may be incorporated into one or more user profiles.

In some instances, the profile attribute generator 206 may evaluate the inference confidence score associated with each received inferred preference and attribute to determine whether the inferred preference and attribute should be processed further. As noted above, the family profiling system 106 may establish a confidence threshold that may be used to determine whether an inferred preference or attribute extracted from a user response can be considered a profile attribute that may be added to a user profile. For instance, if an inferred preference or attribute extracted from a response is assigned an inference confidence score that is below the confidence threshold, the profile attribute generator 206 may automatically determine that the inferred preference or attribute has a low likelihood of being a profile attribute that may be incorporated into a user profile. Accordingly, the profile attribute generator 206 may discard the key-value pair corresponding to this inferred preference or attribute. Alternatively, if an inferred preference or attribute extracted from a response is assigned an inference confidence score that is equal to or greater than the confidence threshold, the profile attribute generator 206 may determine that the inferred preference or attribute corresponds to a profile attribute that should be added to a user profile.

For any inferred preferences and attributes that satisfy the inference score threshold, the profile attribute generator 206, through the one or more LLMs or other generative artificial intelligence processes may evaluate the user profiles corresponding to the family unit 112 according to the knowledge graph and vector store from the user profile database 110 to determine whether to merge these inferred preferences and attributes with existing attributes defined in the user profiles. For instance, a user profile may include data corresponding to different attributes that have been confirmed by the corresponding user (i.e., family member) or rejected by the corresponding user. The profile attribute generator 206, through the one or more LLMs or other generative artificial intelligence processes and using the knowledge graph and vector store, may compare an obtained inferred preference or attribute to the user attributes defined in the user profiles associated with the family unit 112 and the data corresponding to confirmed and rejected attributes to determine whether the inferred preference or attribute may be merged with an existing user profile. If the profile attribute generator 206 determines that an inferred preference or attribute is associated with a user attribute that was previously rejected by the corresponding family member, the profile attribute generator 206 may discard the inferred preference or attribute. Alternatively, if the inferred preference or attribute is associated with a user attribute that has not been previously associated with the family member or is associated with an existing user attribute within the user profile, the profile attribute generator 206 may merge this inferred preference or attribute with the user profile to associate this inferred preference or attribute with the family member.

As noted above, the family profiling system 106 continuously, and in real-time, processes structured and unstructured data, as well as data corresponding to uploaded images, recordings, and other media, from different ongoing communications sessions and from the third-party data sources 116 to continuously update and refine the user profiles associated with the family members associated with the family unit 112. This may ensure that the user profiles accurately convey the unique attributes of each family member within the family unit 112. Further, this may ensure that the relationships between these family members as defined through the user profiles closely mirror the unique dynamics of the family unit 112. This may allow the family profiling system 106, through the automated agents 104, to better communicate with the different family members according to their unique attributes and according to the identified dynamics of the family unit 112.

Further, as noted above, the family profiling system 106, through the continuous processing of this structured and unstructured data and data corresponding to uploaded images, recordings, and other media from different ongoing communications sessions and from the third-party data sources 116, improves the functionality of the various systems and processes of the family-based wellness service. Returning to an earlier illustrative example, by dynamically updating and refining the user profiles associated with the family members as these family members engage in different ongoing communications sessions and with third-party data sources 116, the number of prompts provided by automated agents 104 to these family members may be reduced, as these automated agents 104 may no longer be required to directly prompt these family members for information corresponding to the unique dynamics of the family unit 112 and to the unique attributes of each of the family members. By reducing the number of prompts required to obtain this data, the processing requirements of the family-based wellness service are reduced, thereby improving the efficiency of the various systems and processes of the family-based wellness service.

In an embodiment, the profile attribute generator 206 can refine the user and family profiles according to the frequency in which previously identified attributes are reinforced through processing of ongoing structured and unstructured data exchanged among the different family members associated with the family unit 112, the automated agents 104, and third-party data sources 116. For example, when a user or family attribute is added to a corresponding user or family profile, the profile attribute generator 206 may assign an initial confidence score corresponding to this attribute. This initial confidence score may correspond to the inference confidence score calculated by the data extraction module 204. Over time, as the profile attribute generator 206 receives new inferred preferences and attributes, as well as corresponding inference confidence scores, from the data extraction module 204, the profile attribute generator 206 may determine whether these new inferred preferences and attributes correspond to existing preferences and attributes defined in a user or family profile, subject to the provided inference confidence scores. If an inference confidence scores corresponding to an inferred preference or attribute satisfies the aforementioned inference confidence score threshold and corresponding to an existing preference or attribute defined in a user or family profile, the profile attribute generator 206 may determine that a new utterance corresponding to this preference or attribute has been detected. This may cause the profile attribute generator 206 to maintain or reinforce the confidence score corresponding to this preference or attribute, thereby retaining the preference or attribute within the user or family profile.

In an embodiment, over time, if the profile attribute generator 206 does not receive any new inferred preferences and attributes that satisfy the inference confidence score threshold and that correspond to a particular preference or attribute, the profile attribute generator 206 automatically reduces the confidence score corresponding to the preference or attribute. For example, if a user profile denotes that a particular family member enjoys crocheting, but the profile attribute generator 206 does not receive any new inferred preferences or attributes that reinforce this family member's enjoyment of crocheting, the profile attribute generator 206 may reduce the confidence score corresponding to the family member's enjoyment of crocheting. If this confidence score, at any point, falls below a confidence score threshold maintained by the profile attribute generator 206, the profile attribute generator 206 may automatically remove this preference or attribute from the user or family profile, as this preference or attribute may no longer be relevant.

In some instances, certain defined attributes or preferences may be defined as fundamental and may not be removed even if these attributes or preferences are not referred to again by family members. For example, attributes that denote the relationships among the different family members of the family unit 112 may be deemed fundamental, whereby these attributes may not be automatically removed by the profile attribute generator 206. As another illustrative example, attributes corresponding to medical conditions (e.g., allergies, illnesses, surgeries, etc.) may also be deemed fundamental and may not be automatically removed by the profile attribute generator 206. In an embodiment, the profile attribute generator 206 maintains, for certain types or categories of preferences or attributes, a set of rules or policies that may be applied to corresponding preferences or attributes in the event that corresponding confidence scores fall below the confidence score threshold. For example, if the confidence score corresponding to a user attribute associated with a medical condition falls below the confidence score threshold, the profile attribute generator 206 may identify any applicable rules or policies to determine what action is to be performed. This action may include prompting the family member to confirm whether the preference or attribute is still relevant to the family member. Based on the response from the family member, the profile attribute generator 206 may determine whether to maintain or remove the particular preference or attribute. As another illustrative example, the applicable rules or policies may denote a less stringent confidence score threshold for the particular preference or attribute type or category such that the preference or attribute may be maintained within the user or family profile even if the confidence score falls below the initial confidence threshold. If the confidence score for the preference or attribute, at a later time, falls below the confidence threshold denoted in the applicable rules or policies, the profile attribute generator 206 may remove the preference or attribute from the profile, prompt a family member to determine whether the preference or attribute is still relevant, or any other such action as defined in the applicable rules or policies.

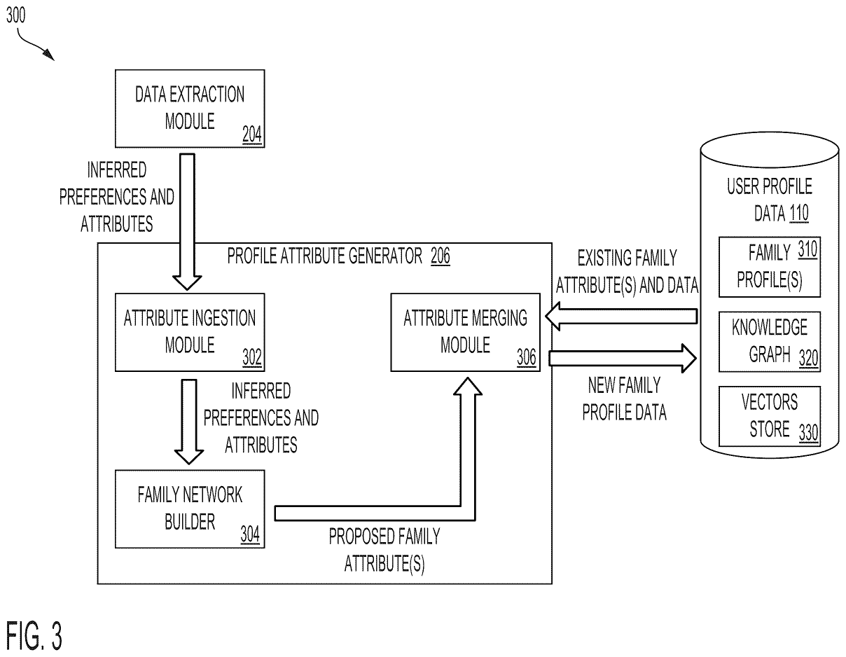

FIG. 3 shows an illustrative example of an environment 300 in which a profile attribute generator 206 evaluates proposed family member attributes and family unit attributes to determine whether to merge the proposed family member attributes and family unit attributes with known attributes within existing family-based user profiles in accordance with at least one embodiment. In the environment 300, the profile attribute generator 206 implements an attribute ingestion module 302 that is configured to obtain, from the data extraction module 204, inferred preferences and attributes corresponding to different family members of a family unit and/or to the family unit itself in real-time as these inferred preferences and attributes are generated. The attribute ingestion module 302 may be implemented using a computer system or as an application or other executable code implemented on a computer system of the profile attribute generator 206. In an embodiment, the attribute ingestion module 302 automatically monitors the data extraction module 204 to identify and automatically retrieve any newly generated inferred preferences and attributes generated by the data extraction module 204. In some instances, the attribute ingestion module 302 may automatically receive these newly generated inferred preferences and attributes as these inferred preferences and attributes are pushed to the attribute ingestion module 302 by the data extraction module 204.

As noted above, the inferred preferences and attributes may be provided to the profile attribute generator 206 with corresponding inference confidence scores. In an embodiment, the attribute ingestion module 302 evaluates each obtained inferred preference or attribute according to an inference score threshold to determine whether the inferred preference or attribute may be considered for inclusion as an attribute within a user profile and/or family unit profile. Returning to an earlier illustrative example, if an inferred preference or attribute extracted from a response is assigned an inference confidence score that is below the inference confidence threshold, the attribute ingestion module 302 may automatically determine that the inferred preference or attribute has a low likelihood of being a profile attribute that may be incorporated into a user or family unit profile. Accordingly, the attribute ingestion module 302 may automatically discard the key-value pair corresponding to this inferred preference or attribute. Alternatively, if an inferred preference or attribute extracted from a response is assigned an inference confidence score that is equal to or greater than the confidence threshold, the attribute ingestion module 302 may determine that the inferred preference or attribute corresponds to a profile attribute that should be added to a user and/or family unit profile.

The attribute ingestion module 302 may automatically transmit any inferred preferences and attributes having inference confidence scores greater than the inference score threshold to a family network builder 304 for further processing. The family network builder 304 may be implemented using a computer system or as an application or other executable code implemented on a computer system of the profile attribute generator 206. In an embodiment, the family network builder 304 implements one or more LLMs or other generative artificial intelligence processes that are dynamically trained to evaluate obtained inferred preferences and attributes to identify different user and family attributes that may be assigned to one or more profiles within the user profile database 110 and that may be used to link these one or more profiles as being part of a singular family unit. Further, the one or more LLMs or other generative artificial intelligence processes may be dynamically trained to identify different user and family attributes that may be assigned to the family unit globally through a family unit profile.

Returning to an earlier illustrative example, where a family member has indicated to an automated agent that the family unit includes two other individuals (e.g., “Miya” and “Maxine”), the family network builder 304 may evaluate the inferred preferences and attributes corresponding to these two other individuals to determine that these two other individuals are part of the same family unit as the family member conversing with the automated agent. This may cause the family network builder 304 to annotate the inferred preferences and attributes associated with these two individuals to denote the relationship between these two individuals and the family member and the definition of the family unit to which the two individuals and the family member belong to. As the family network builder 304 defines relationships between the different inferred preferences and attributes corresponding to different family members, the family network builder 304 may dynamically generate proposed family member attributes that may be incorporated into the user profiles corresponding to these different family members to further refine these user profiles and to further amplify the relationship among these different family members within the family unit. Further, the family network builder 304 may dynamically generate proposed family attributes that may be incorporated into the family unit profile to further define the dynamics of the family unit. The family network builder 304 may automatically provide these proposed family member attributes to an attribute merging module 306 for evaluation and incorporation into the user profile database 110.

The attribute merging module 306 may be implemented using a computer system or as an application or other executable code implemented on a computer system of the profile attribute generator 206. In an embodiment, the attribute merging module 306, through one or more LLMs or other generative artificial intelligence processes, may evaluate the family profiles 310 corresponding to the family unit (i.e., profiles corresponding to individual family members and a profile corresponding to the family unit) according to a knowledge graph 320 and vectors store 330 from the user profile database 110 to determine whether to merge these proposed family member attributes with existing attributes defined in the family profiles 310. Returning to an earlier illustrative example, a family profile may include data corresponding to different attributes that have been confirmed by the corresponding family member or rejected by the corresponding family member. The attribute merging module 306, through the one or more LLMs or other generative artificial intelligence processes and using the knowledge graph 320 and vectors store 330, may compare an obtained proposed family attribute for a particular family member or the family unit as a whole to the known attributes defined in the particular family member's or family unit's profile and data corresponding to confirmed and rejected attributes to determine whether the proposed family attribute may be merged with the family member's or family unit's existing profile. If the attribute merging module 306 determines that a proposed family attribute is associated with an attribute that was previously rejected by the corresponding family member, the attribute merging module 306 may discard the proposed family attribute. Alternatively, if the proposed family attribute is associated with an attribute that has not been previously associated with the family member or is associated with an existing user attribute within the family member's profile, the attribute merging module 306 may merge this inferred preference or attribute with the family member's or family unit's profile to associate this proposed family attribute with the family member or family unit, respectively.

In an embodiment, if the attribute merging module 306 determines that a proposed family attribute is not associated with any known family profiles 310 maintained in the user profile database 110, the attribute merging module 306 can automatically generate a new family member profile corresponding to this newly identified family member and incorporate this proposed family attribute into the new family member profile. Returning to an earlier example, where a family member has provided a response to a prompt that names two other family members within the family unit, the attribute merging module 306 may dynamically generate two new family member profiles in the user profile database 110 for these two other family members if there are no existing family member profiles corresponding to these two other family members. Further, the attribute merging module 306 may update the family profile associated with the family unit to indicate that these other family members are associated with the family unit.

In some instances, using the knowledge graph 320 and the vectors store 330, the attribute merging module 306 may further merge the new family attributes with existing family attributes within different family member profiles based on the relationship among the different family members in the family unit. For example, if a proposed family attribute denotes that Miya is Joe's daughter, the attribute merging module 306 may use the knowledge graph 320 and the vectors store 330 to determine that the proposed family attribute is to be incorporated into Miya's profile and into Joe's profile to denote the relationship between Miya and Joe. This may result in Miya's profile denoting that she is Joe's daughter within the family unit. This may further result in Joe's profile denoting that he is Miya's father within the family unit. As another illustrative example, if a proposed family attribute indicates that the family unit is vegan, the attribute merging module 306 may access a family profile corresponding to this family unit to identify the different family members associated with the family unit. Further, based on this identification of the different family members that are part of the family unit, the attribute merging module 306 may access the corresponding family member profiles and update these corresponding family member profiles to denote that these family members are vegan.

It should be noted that the components of the profile attribute generator 206 continuously, and in real-time, process inferred preferences and attributes corresponding to different family members and family units to continuously update and refine the family member profiles 310 associated with the family members and the family unit. This may ensure that the user profiles accurately convey the unique attributes of each family member within the family unit. Further, this may ensure that the relationships between these family members as defined through these family member profiles 310 closely mirror the unique dynamics of the family unit. This may allow the family-based wellness service, through the aforementioned automated agents, to better communicate with the different family members according to their unique attributes and according to the identified dynamics of the family unit.

In an embodiment, the attribute merging module 306 continuously monitors and tracks the frequency in which previously identified attributes are encountered for the different family members associated with a family unit and for the family unit itself. As noted above, when a user of family attribute is added to a corresponding user or family profile, the profile attribute generator 206 may assign an initial confidence score corresponding to this attribute. The initial confidence score may correspond to the inference confidence score that was previously calculated by the data extraction module 204. In an embodiment, as the attribute merging module 306 receives new proposed family attributes from the family network builder 304, the attribute merging module 306 may use the knowledge graph 320 and the vectors store 330 to determine whether the new proposed family attributes correspond to existing family attributes defined in applicable family profiles. If the attribute merging module 306 determines that a new proposed family attribute corresponds to an existing family attribute within an applicable family profile (i.e., a family member profile or family unit profile), the attribute merging module 306 may determine that a new utterance corresponding to this attribute has been detected. Accordingly, the attribute merging module 306 may update the confidence score for this particular attribute to reinforce the level of relevance of the attribute to the corresponding family member or family unit.

In an embodiment, using the knowledge graph 320 and the vectors store 330, the attribute merging module 306 can dynamically adjust the confidence score of each attribute according to the frequency in which the attribute is encountered over time. For example, the attribute merging module 306 may periodically determine, for each attribute indicated in a family member profile or family unit profile, whether a new utterance of the attribute has been provided by the family network builder 304. If the attribute merging module 306 determines that a new utterance of the attribute has not been detected, the attribute merging module 306 may dynamically adjust the confidence score corresponding to this attribute to indicate a lower relevance of the attribute. Returning to an earlier illustrative example, if a family member profile denotes that a particular family member enjoys crocheting, but the attribute merging module 306 does not receive any proposed attributes that would reinforce this family member's enjoyment of crocheting, the attribute merging module 306 may reduce the confidence score corresponding to this attribute.

Once the attribute merging module 306 adjusts the confidence score for a particular attribute, the attribute merging module 306 may determine whether this adjusted confidence score falls below the confidence score threshold maintained by the profile attribute generator 206. The confidence score threshold may denote a minimum confidence score required for determining that an attribute is relevant to a family member or family unit. In an embodiment, if the attribute merging module 306 determines that the adjusted confidence score falls below this confidence score threshold, the attribute merging module 306 determines whether this attribute is subject to any rules or policies defining the actions to be taken as a result of the adjusted confidence score falling below this threshold. If there are no applicable rules or policies, the attribute merging module 306 may automatically remove this attribute from the family member or family unit profile.

As noted above, certain attribute types or categories may be deemed fundamental and may not be removed even if the confidence score for an attribute within any of these attribute types or categories falls below the confidence score threshold. Returning to an earlier illustrative example, attributes that denote the relationships among the different family members of the family unit may be deemed fundamental, whereby these attributes may not be automatically removed by the attribute merging module 306. As another illustrative example, attributes corresponding to medical conditions (e.g., allergies, illnesses, surgeries, etc.) may also be deemed fundamental and may not be automatically removed by the attribute merging module 306. In some instances, if an attribute is subject to one or more rules or policies, the attribute merging module 306 may evaluate these one or more rules or policies to determine what action is to be taken as a result of a corresponding confidence score falling below the confidence score threshold. This action may include prompting a family member to confirm whether the attribute is still relevant to the family member. Based on the response from the family member, the attribute merging module 306 may determine whether to maintain or remove the particular preference or attribute. As another illustrative example, the applicable rules or policies may denote a less stringent confidence score threshold for the particular preference or attribute type or category such that the attribute may be maintained within the family member or family unit profile even if the confidence score falls below the initial confidence threshold. If the confidence score for the attribute, at a later time, falls below the confidence threshold denoted in the applicable rules or policies, the attribute merging module 306 may remove the attribute from the profile, prompt a family member to determine whether the attribute is still relevant, or any other such action as defined in the applicable rules or policies.

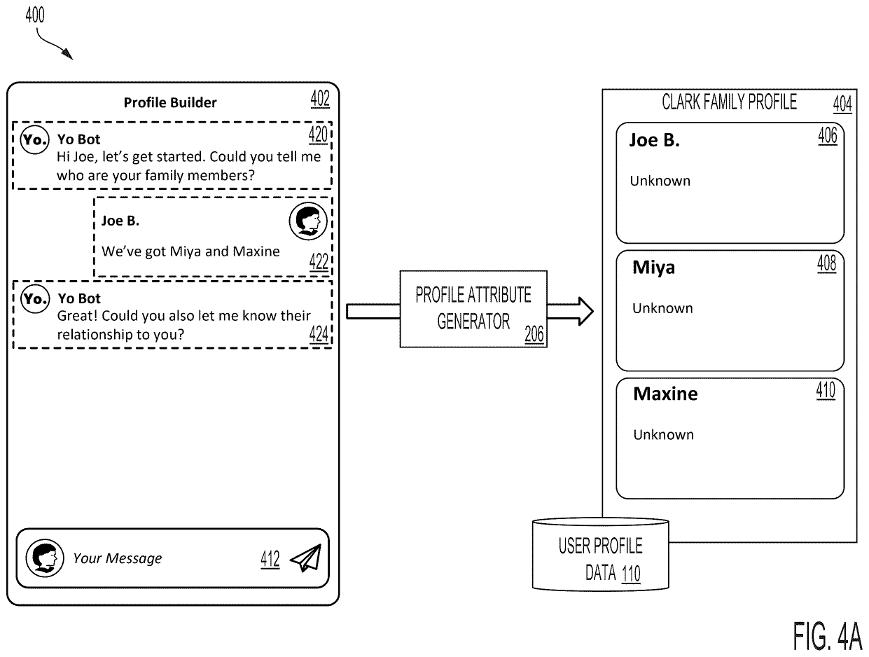

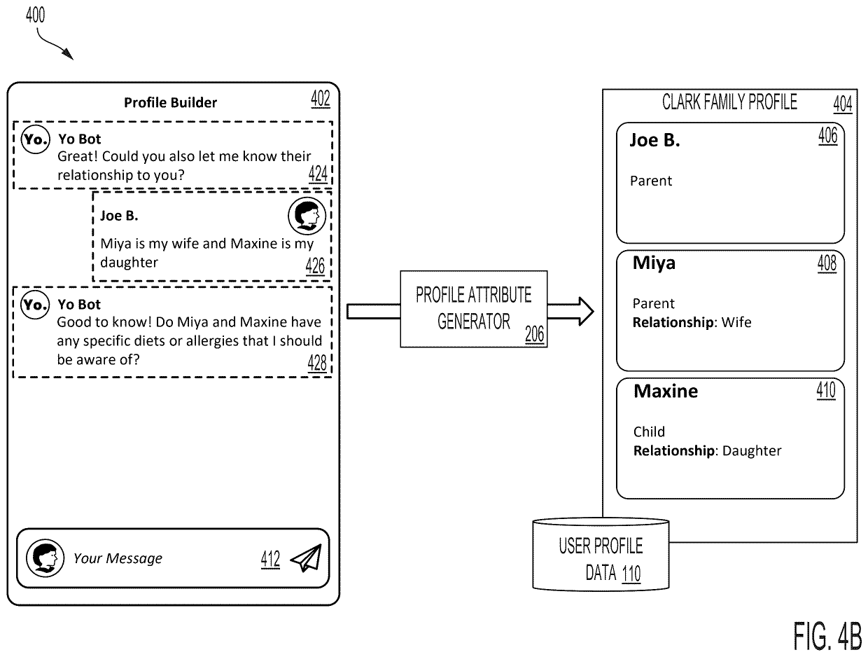

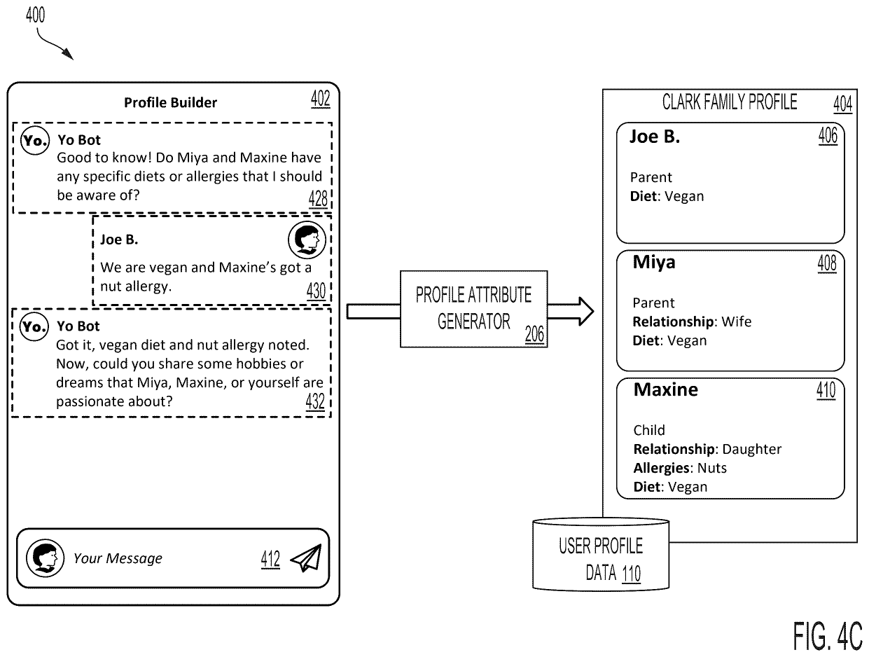

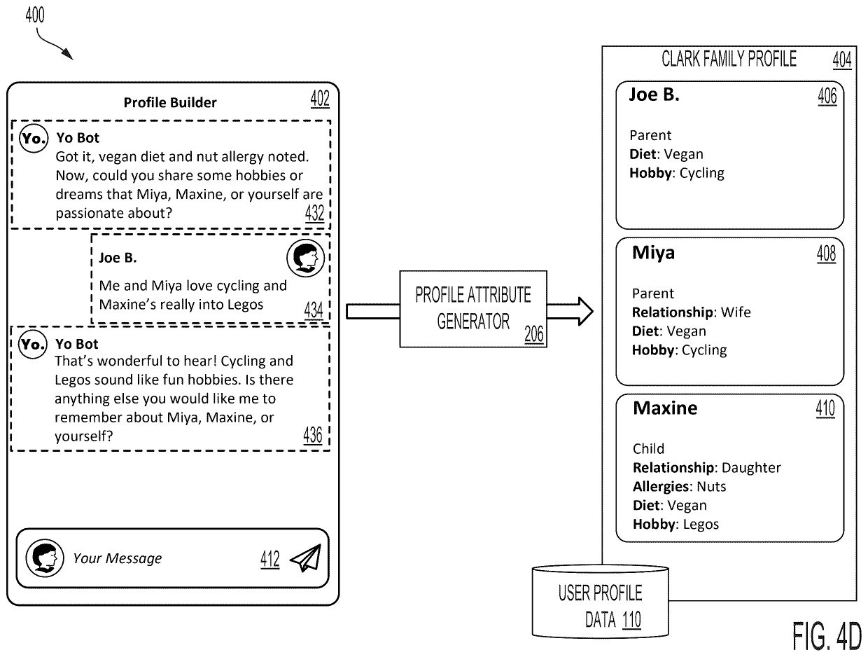

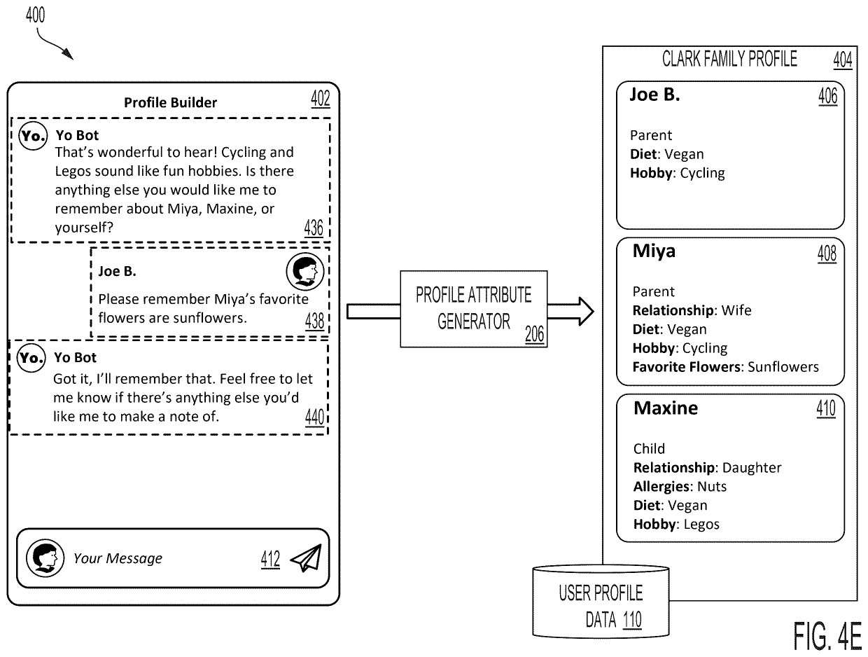

FIGS. 4A-4E show an illustrative example of an environment 400 in which a profile attribute generator 206 dynamically generates and updates different family-based user profiles 406-410 corresponding to a family unit based on real-time communications exchanged between a family member and an automated agent in accordance with at least one embodiment. In the environment 400, a particular family member associated with a family unit may be engaged in a communications session with an automated agent through an interface 402 provided by the family-based wellness service. As noted above, the family-based wellness service may provide an application or web service through which users may access an interface 402 for initiating and engaging in communications sessions with automated agents to address different user intents. For example, the family-based wellness service may provide, to a family member, an application that may be installed and executed from the family member's computing device to access, through the interface 402, the family-based wellness service. Additionally, or alternatively, a family member, through a browser application installed and executed from the family member's computing device, may access a website associated with the family-based wellness service and through which the family-based wellness service implements a web service that includes the interface 402.

As illustrated in FIG. 4A, when the family member (i.e., “Joe B.”) accesses the interface 402 and initiates the communications session with an automated agent implemented by the family-based wellness service, the automated agent may determine that the family member is accessing the family-based wellness service for the first time and is to be guided through an onboarding process. Through this onboarding process, the automated agent may prompt the family member to provide information regarding the family member and any other family members that may comprise the family unit in order to construct and update a family unit profile 404 corresponding to the family unit and different family member profiles 406-410 corresponding to different members of the family unit. For example, the automated agent may transmit, through the interface 402, a prompt 420 to the family member to identify any other members of the family unit. In response to the prompt 420, the family member may submit a response 422 through an input field 412 provided through the interface 402. As illustrated in FIG. 4A, this response 422 may indicate that in addition to “Joe B.,” the family unit includes two other family members: “Miya” and “Maxine.”

As noted above, responses provided by family members through ongoing communications sessions between these family members and automated agents may be processed to extract any inferred preferences and attributes that may be processed to identify any user attributes that may be associated with these family members and to define any relationships among these family members within a family unit. These inferred preferences and attributes may be evaluated by a profile attribute generator 206, as described above, to identify any user attributes that may be incorporated into family member profiles and used to enhance any relationships among family members as defined through the family unit profile. Returning to the illustrative example provided in FIG. 4A, the profile attribute generator 206 may evaluate the response 422 to determine that the family unit (e.g., the “Clark Family”) includes two family members in addition to Joe B., namely Miya and Maxine. The profile attribute generator 206 may query the user profile database 110 to access the family unit profile 404 corresponding to the Clark Family and determine whether there are existing family member profiles corresponding to Joe B., Miya, and Maxine. Based on this evaluation, the profile attribute generator 206 may dynamically generate new family member profiles for any identified family members who are not associated with an existing family member profile. For instance, while Joe B. may have an existing family member profile 406, the profile attribute generator 206 may need to generate new family member profiles 408 and 410 for Miya and Maxine, respectively. Further, since these two new family member profiles 408 and 410 correspond to family members that are related to Joe B. and that are part of the Clark Family, the profile attribute generator 206 may automatically associate these new family member profiles 408 and 410 with the family unit profile 404.

In an embodiment, the family profiling system 106 described above in connection with FIGS. 1-2, dynamically processes any responses submitted through the interface 402 through one or more LLMs or other generative artificial intelligence processes to generate new messages that may be communicated to a family member through the interface 402 and that are responsive to the communications submitted by the family member. As noted above, these one or more LLMs or other generative artificial intelligence processes may be dynamically trained using a dataset comprising a large corpus of sample communications/messages (e.g., historical communications/messages, hypothetical communications/messages, combinations of historical and hypothetical communications/messages, etc.), and sample responses to the communications/messages. The one or more LLMs and/or other generative artificial intelligence processes may be initialized with a first set of values corresponding to different hyperparameters or other coefficients that, in combination, are used to derive an output given a sample input (e.g., sample communications/messages). For instance, the family profiling system may initialize a set of coefficients or other hyperparameters randomly according to a Gaussian distribution with low variance centered around zero. Using this initial iteration of the one or more LLMs or other generative artificial intelligence processes, the family profiling system may process the dataset of sample communications/messages to generate an output. This output may specify, for each sample communication or message, a response to the communication or message (e.g., an extracted attribute or preference, a message to be communicated, etc.). The one or more LLMs or other generative artificial intelligence processes may compare the output (e.g., predicted response message to be communicated, etc.) to the expected responses included in the dataset. Based on this comparison, the one or more LLMs or other generative artificial intelligence processes may dynamically update the values corresponding to the different hyperparameters or other coefficients and again process the dataset to generate new outputs. This process may be repeated numerous times until an iteration of the one or more LLMs or other generative artificial intelligence processes is obtained that satisfies one or more accuracy or predictability thresholds.

The one or more LLMs or other generative artificial intelligence processes, through this training process, may be trained to determine the context of any responses submitted by family members and determine what additional information may be required of these family members to further refine the family member profiles associated with the family unit. Returning to the illustrative example provided in FIG. 4A, in response to the family member indicating that the family unit further includes Miya and Maxine, the one or more LLMs or other generative artificial intelligence processes may generate an output includes a new message 424 that provides a prompt for additional information regarding Miya and Maxine's relationships to Joe B. Accordingly, the automated agent, through the interface 402, may provide the new message 424 and thus prompt Joe B. to indicate what Miya and Maxine's relationships to Joe B. are.

As illustrated in FIG. 4B, the family member (i.e., Joe B.) has provided a response 426 indicating that Miya is his wife and that Maxine is his daughter. The profile attribute generator 206 may evaluate the inferred attributes extracted from this response 426 against the family member profiles 406-410 corresponding to Joe B., Miya, and Maxine, respectively, to determine whether these inferred attributes may be incorporated into the family member profiles 406-410. As illustrated in FIG. 4A, these family member profiles 406-410 may have previously been devoid of any attributes as they had not been previously defined by any family member associated with the family unit. Thus, the profile attribute generator 206, based on the inferred attributes extracted from the response 426, may update Joe B. and Miya's family member profiles 406-408 to indicate that they are parents within the family unit. Further, the profile attribute generator 206 may update Maxine's family member profile 410 to indicate that she is a child within the family unit. Additionally, based on the inferred attributes extracted from the response 426, the profile attribute generator 206 may determine that these inferred attributes further define relationships among these family members that should be denoted in the family member profiles 406-410. For instance, as illustrated in FIG. 4B, the profile attribute generator 206 may update Miya's family member profile 408 to indicate that she is Joe B.'s wife. Further, profile attribute generator 206 may update Maxine's family member profile 408 to indicate that she is Joe B.'s daughter. Thus, through evaluation of inferred attributes, the profile attribute generator 206 may refine the family unit profile 404 to indicate the various relationships among different family members within the family unit.

Based on the response 426, the one or more LLMs or other generative artificial intelligence processes may generate an output that includes a new message 428 that provides a prompt for additional information regarding any specific dietary restrictions or allergies associated with the different family members of the family unit that should be indicated in the corresponding family member profiles 406-410. Accordingly, the automated agent, through the interface 402, may provide the new message 428 and thus prompt Joe B. to indicate any specific diets or allergies that the family members may have.

As illustrated in FIG. 4C, Joe B. has provided a response 430 indicating that the family unit is vegan and that Maxine, his daughter, has a nut allergy. Based on this response 430, the family profiling system may extract an inferred attribute corresponding to Maxine's nut allergy and an inferred attribute for the family unit corresponding to the family unit being vegan. Accordingly, the profile attribute generator 206 may update Maxine's family member profile 410 to indicate that she has a nut allergy. Additionally, since the inferred attribute corresponding to the family unit's vegan diet is universal for all family members of the family unit, the profile attribute generator 206 may update all of the family member profiles 406-410 to indicate that each family member of the family unit practices a strict vegan diet. Thus, as demonstrated in FIG. 4C, the family profiling system and particularly the profile attribute generator 206 may dynamically identify personal attributes and universal family unit attributes and apply these attributes to different family member profiles accordingly.

In addition to updating the family member profiles 406-410, and based on the response 430 and all prior responses provided by the family member through the interface 402, the one or more LLMs or other generative artificial intelligence processes may generate an output that includes a new message 432 that provides a prompt for additional information regarding any hobbies or dreams associated with the different family members of the family unit that should be indicated in the corresponding family member profiles 406-410. Accordingly, the automated agent, through the interface 402, may provide the new message 432 and thus prompt Joe B. to indicate any hobbies or dreams that the family members may have.

As illustrated in FIG. 4D, Joe B. has provided a response 434 indicating that he and Miya love cycling and that Maxine is into Legos. Based on this response 434, the family profiling system may extract an inferred attribute corresponding to Joe B. and Miya's cycling hobby and a separate inferred attribute corresponding to Maxine's Legos hobby. Accordingly, the profile attribute generator 206 may update Maxine's family member profile 410 to indicate that her hobby is to play with Legos. Additionally, the profile attribute generator 206 may update Joe B. and Miya's family member profiles 406 and 408 to indicate that their shared hobby is cycling.

In an embodiment, the prompt for additional information regarding any hobbies or dreams associated with the different family members of the family unit may be provided to solicit information that may be used to derive one or more goals for the family unit and, based on these goals, identify a set of tasks that may be performed to accomplish these goals. As noted above, the family-based wellness service may implement a task recommendation service that generates and provides recommendations for different tasks that a family unit may engage in according to indicated or inferred goals. The task recommendation service implements and dynamically trains a machine learning algorithm or artificial intelligence to process the communications exchanged during an ongoing communications session between one or more family members of a family unit and one or more automated agents to identify a goal that the family unit would like to achieve and one or more tasks that may be performed by these family members to achieve the goal. As illustrated in FIG. 4D, the purpose of prompting Joe B. to indicate any hobbies or dreams that the family members of the family unit may be interested in is to elicit information that may be used to infer a goal that the family unit may wish to achieve in order to improve the wellness of the family unit.

Based on Joe B.'s indication that he and Miya are interested in cycling, the task recommendation system, through the machine learning algorithm or artificial intelligence, may dynamically define a goal for Joe B. and Miya to engage in cycling-related activities over a period of time (e.g., go cycling for 30 minutes each day, go on a two-hour cycling trip once a week, etc.). This goal may be defined according to the attributes defined Joe B. and Miya's family member profiles 406-408 and any ongoing tasks associated with Joe B. and/or Miya that may impede their ability to achieve this goal. Additionally, the task recommendation system may evaluate these family member profiles 406-408 to identify each family member's role within the family unit, which may inform what tasks may be assigned to Joe B. and to Miya in order to achieve the cycling goal. In some instances, the task recommendation system may further identify, based on the family member profiles 406-408, different family member idiosyncrasies that may inform the task recommendation system as to how to encourage the Joe B. and Miya to perform the assigned tasks and achieve the goal.

In addition to updating the family member profiles 406-410, and based on the response 434 and all prior responses provided by the family member through the interface 402, the one or more LLMs or other generative artificial intelligence processes may generate an output that includes a new message 436 that provides a prompt for any additional information that may be used to supplement the family member profiles 406-410 and that may be used to identify different tasks, goals, idiosyncrasies, or other unique characteristics of each of the family members or of the family unit as a whole. Accordingly, the automated agent, through the interface 402, may provide the new message 436 and thus prompt Joe B. to indicate any additional information about the family unit.

In an embodiment, the one or more LLMs or other generative artificial intelligence processes can generate an output that corresponds to a request for an image, recording, or other media that may be processed to extract additional information used to supplement the family member profiles 406-410. Returning to the illustrative example provided in FIG. 4D, where Joe B. has indicated that he and Miya love cycling and that Maxine is into Legos, the one or more LLMs or other generative artificial intelligence processes may generate an output that corresponds to distinct requests for images of Joe B. and Miya cycling and of Maxine playing with Legos. In some instances, Joe B. may be incentivized to upload these images. For example, the automated agent may indicate, through the interface 402, that Joe B. may be awarded with a set number of experience points for providing the requested images. As noted above, each family member, through their respective version of the application installed on their family unit computing devices, may receive a notification or other indication of the awarding of experience points to the family member that uploaded a requested image or other recording. This may serve as a motivator to the other family members to upload their own images or other recordings to earn their own experience points.

If Joe B. uploads the requested images, the family profiling system may process these images using the aforementioned neural network or computer vision models to extract any family member attributes that may be used to update each family member's profile. For example, if an image of Joe B. and Miya cycling shows that Joe B. and Miya ride mountain bikes and are on a wilderness trail, the family profiling system may extract inferred attributes corresponding to Joe B. and Miya's specific interest in mountain biking and forestry. Accordingly, the profile attribute generator 206 may update Joe B. and Miya's profiles 406 and 408 to refine their preferred hobby from “cycling” to “mountain biking.” Further, the profile attribute generator 206 may update these profiles 406 and 408 to indicate that Joe B. and Miya also enjoy forestry-related activities. Thus, through the processing of images, recordings, and other media, the family profiling system may extract additional family member attributes that may not have been expressly stated by these family members through the ongoing communications sessions.

As illustrated in FIG. 4E, Joe B. has provided a response 438 indicating that Miya's favorite flowers are sunflowers. Based on this response 438, the family profiling system may extract an inferred attribute corresponding to Miya's love of sunflowers. Accordingly, the profile attribute generator 206 may update Miya's family member profile 408 to indicate that her favorite flowers are sunflowers. In addition to updating the family member profiles 408, and based on the response 438 and all prior responses provided by the family member through the interface 402, the one or more LLMs or other generative artificial intelligence processes may generate an output that includes a new message 440 that includes an acknowledgment of Joe B.'s response 438 and an indication that Joe B. is welcome to provide, through the interface 402, any additional information that may be helpful in updating the family member profiles 406-410.

As noted above, as different family members of a family unit communicate with one or more automated agents through ongoing communications sessions (such as through the interface 402), the profile attribute generator 206 may continue to update corresponding family member profiles and refine different family unit connections among different family members of the family unit to provide accurate and detail information about these different family members and of the family unit as whole. Further, the profile attribute generator 206, through the one or more LLMs or other generative artificial intelligence processes, may continuously generate new prompts for additional information, as needed, to further refine the family unit and family member profiles and enable further understanding of the unique idiosyncrasies associated with each family member and of the family unit as a whole. This continuous update of family unit and family member profiles, as described above, may allow the task recommendation system to dynamically identify goals associated with the family unit that may be implemented to improve the wellness of the family unit. Further, based on the family unit and family member profiles, the task recommendation system may dynamically identify different tasks that may be assigned to the different family members of a family unit to achieve these identified goals.

It should be noted that while FIGS. 4A-4E illustrate different family member attributes in the form of distinct lists for each family member, these different family member attributes may be represented within the family member profiles 406-410 and/or the family unit profile 404 through different methods. For instance, the profile attribute generator 206 may dynamically generate a summary of the structured and/or unstructured data processed by the family profiling system to identify the new attribute being introduced into a family member profile or family unit profile. As an illustrative example, the profile attribute generator 206, through the one or more LLMs or other generative artificial intelligence processes, may dynamically process any communications associated with the identified attribute and generate a summary of these communications that may be added to the corresponding family member profile or family unit profile. This summary may provide additional context with regard to the identified attribute.

In an embodiment, the family profiling system (through the profile attribute generator 206) allows family members to update their individual family member profiles and, in some instances, the family unit profile. For instance, through the interface 402, a family member may access their individual family member profile to review the various attributes assigned to the family member. Based on their review, the family member may add new attributes to their family member profile, remove attributes from their family member profile, and/or modify any attributes indicated in their family member profile. In some instances, certain family members may be authorized to modify the family unit profile and/or the profiles of other family members associated with the family unit. For example, a parent who serves as the patriarch or matriarch of the family unit may be authorized to modify the family member profiles of their children or of other family members that are associated with the family unit. Further, this parent, through the interface 402, may modify the family unit profile to define any global family attributes and/or define relationships among the different family members that make up the family unit.

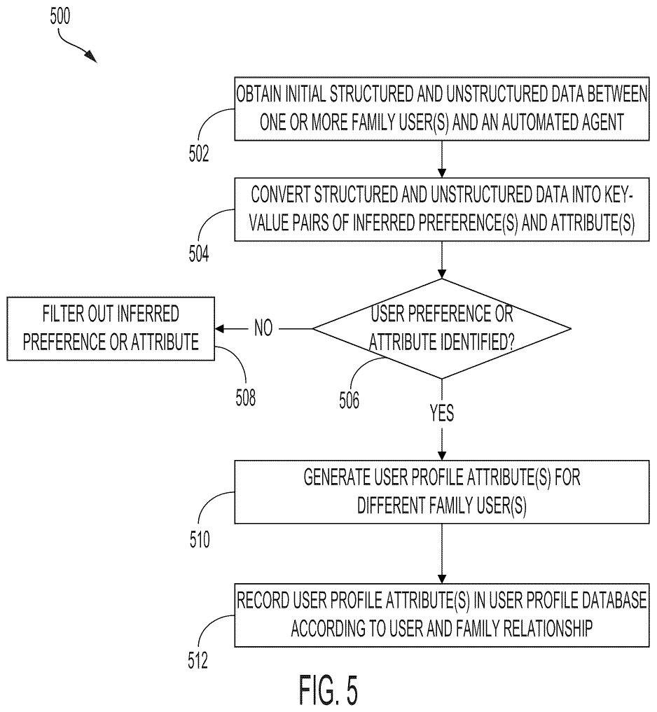

FIG. 5 shows an illustrative example of a process 500 for generating user profile attributes and family-based attribute relationships based on initial structured and unstructured data between one or more users and an automated agent in accordance with at least one embodiment. The process 500 may be performed by the family profiling system and its various components, as described above in connection with FIGS. 1-3. At step 502, the family profiling system may obtain initial structured and unstructured data between one or more family members associated with a family unit and one or more automated agents implemented by the family-based wellness service. As noted above, when a family member initiates a communications session with an automated agent for the first time, the automated agent may initiate an onboarding process to obtain information associated with the family member, of any other family members that may be associated with the family member, and of the family unit as a whole. Through this onboarding process, the automated agent may prompt the family member to provide this information, which may be used to define different attributes associated with the family member, any other family members associated with the family member, and with the family unit as a whole, as described in greater detail herein. Further, in some instances, the automated agent may prompt the family member to provide any images, recordings, or other media that may be processed to extract any defining attributes associated with the family member and/or any other family members. For instance, the automated agent may prompt the family member to upload a photograph of themselves, as well as photographs of any other family members. Additionally, or alternatively, the automated agent may prompt the family member to upload a recording of their voice so that the family profiling system may construct a voice signature of the family member.

At step 504, as the family profiling system receives the initial structured and unstructured data (including any images, recordings, and/or other media) from the automated agent, the family profiling system may convert this structured and unstructured data into one or more key-value pairs corresponding to different inferred preferences and attributes that may be used to define different attributes of the family member, other family members, and/or the family unit. As noted above, as a family member submits a response to a prompt provided by an automated agent, the family profiling system may apply NLP or other language parsing algorithm to automatically parse the response and identify particular terms or phrases that may be used to determine different attributes associated with the family member, other family members, and/or the family unit. These terms or phrases may be used as input to one or more LLMs and/or other generative artificial intelligence processes, causing the one or more LLMs and/or other generative artificial intelligence processes to identify one or more key-value pairs corresponding to inferred preferences and attributes that may be associated with the family members of the family unit. As another illustrative example, if the family member has provided an image of the family member, the family profiling system may process the provided image through one or more computer vision models and/or neural networks to analyze and extract any potential idiosyncrasies or other unique characteristics of the family member (e.g., biometric information, facial characteristics, etc.). Similarly, if the family member has provided an audial recording of the family member, the family profiling system may process this audial recording through one or more computer audition models to analyze and construct an audial signature of the family member.

As noted above, the one or more LLMs and/or other generative artificial intelligence processes implemented by the family profiling system may further calculate an inference confidence score for each key-value pair corresponding to an inferred preference or attribute identified through evaluation of the structured and unstructured data. An inference confidence score may denote a likelihood or confidence that the extracted term (or inferred preference or attribute) corresponds to an attribute that may be associated with a user profile. An inference confidence score for each key-value pair identified by the family profiling system may be calculated using NER tagging, JERL, or any other NLP-based process.

At step 506, the family profiling system may determine whether a family member preference or attribute has been identified that can be added to a new family member profile. As noted above, each inferred preference or attribute may be assigned an inference confidence score. In an embodiment, the family profiling system evaluates the inference confidence score associated with each received inferred preference and attribute to determine whether the inferred preference and attribute should be processed further. For instance, the family profiling system may establish a confidence threshold that may be used to determine whether an inferred preference or attribute extracted from a user response can be considered a profile attribute that may be added to a user profile. If an inferred preference or attribute extracted from a response is assigned an inference confidence score that is below the confidence threshold, the family profiling system may automatically determine that the inferred preference or attribute has a low likelihood of being a profile attribute that may be incorporated into a user profile. Accordingly, the family profiling system, at step 508, may filter out the key-value pair corresponding to this inferred preference or attribute. Alternatively, if an inferred preference or attribute extracted from a response is assigned an inference confidence score that is equal to or greater than the confidence threshold, the family profiling system may determine that the inferred preference or attribute corresponds to a profile attribute that should be added to a user profile.

At step 510, for any identified key-value pairs having inference confidence scores greater than or equal to the inference confidence threshold, the family profiling system may generate corresponding family member profile attributes that may be assigned to different family member profiles. For each new family member profile attribute, the family profiling system may incorporate the corresponding inference confidence score to denote a level of confidence that the attribute accurately reflects a characteristic of the corresponding family member. As described in greater detail herein, this confidence score, as well as a knowledge graph and vectors store maintained by the family-based wellness service, may be used to determine whether to replace or merge existing attributes with newly identified attributes associated with a family member.

At step 512, the family profiling system may record these new family member profile attributes in the user profile database according to family member and family unit relationships. For instance, if a particular family member profile attribute is uniquely associated with a particular family member, the family profiling system may record this family member profile attribute within the family member profile corresponding to the particular family member. As another illustrative example, if a family member profile attribute is associated with the family unit as a whole, the family profiling system may dynamically incorporate this family member profile attribute into each of the family member profiles associated with the family members of the family unit. Further, the family profiling system may link these family member profiles according to this attribute to denote that this attribute is universal to the family unit.

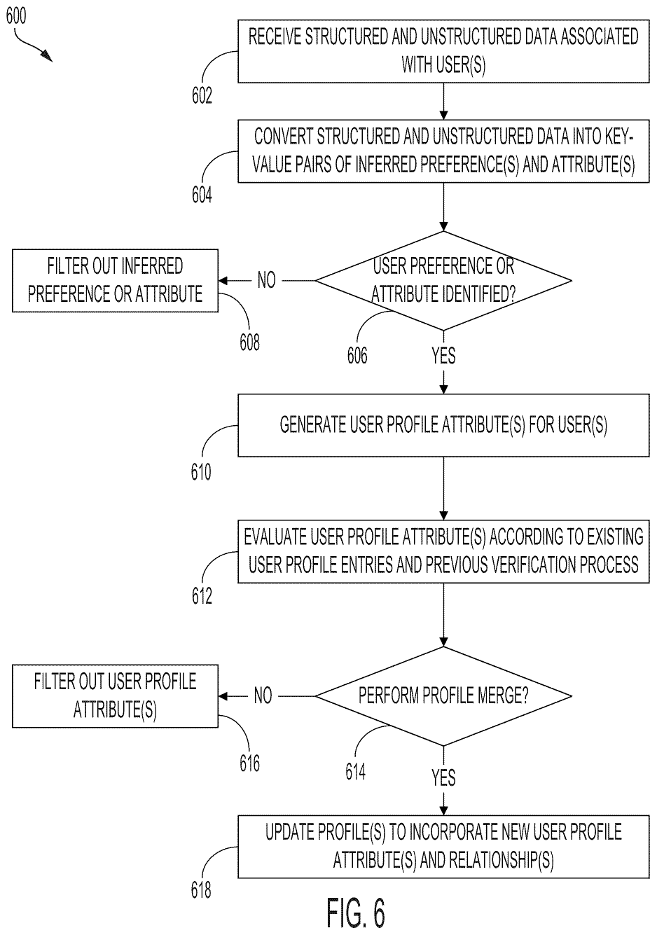

FIG. 6 shows an illustrative example of a process 600 for updating different family-based user profiles and corresponding relationships among the different family-based user profiles based on raw data associated with one or more users in accordance with at least one embodiment. The process 600 may be performed by the family profiling system and its various components, as described above in connection with FIGS. 1-3. At step 602, the family profiling system may receive raw data associated with one or more family members of a family unit. As noted above, the family-based wellness service may implement different communications sessions between different automated agents and different family members of a family unit. This allows the family-based wellness service, through the different communications sessions and different automated agents, to have tailored communications with different family members of the family unit according to the idiosyncrasies of each of these different family members. Additionally, the family-based wellness service may allow different family members of a family unit to communicate with one another through an existing communications session and/or through a new communications session. In an embodiment, as family members associated with the family unit communicate with different automated agents through different ongoing communications sessions, the family profiling system may obtain, in real-time, any communications exchanged between these family members and the different automated agents. Further, the family profiling system may obtain, in real-time, any communications exchanged among the different family members of a family unit without automated agent intervention.

In an embodiment, the raw data can further include family member interactions with one or more third-party data sources. As noted above, when the family members access the family-based wellness service for the first time, the family-based wellness service may prompt these family members to authorize the family-based wellness service to access these third-party data sources to obtain additional data that may be used to enhance these family members'user profiles. The data from these third-party data sources may further indicate different interactions among the family members and other information that may be used to further determine the family dynamics and identify additional user attributes that may be incorporated into the user profiles associated with these family members and the family unit.

At step 604, the family profiling system may convert the obtained raw data into key-value pairs of inferred preferences and attributes. Similar to step 504 described above in connection with FIG. 5, the family profiling system, at step 604, may apply NLP or other language parsing algorithm to automatically parse the raw data and identify particular terms or phrases that may be used to determine different attributes associated with the family member, other family members, and/or the family unit. These terms or phrases may be used as input to one or more LLMs and/or other generative artificial intelligence processes, causing the one or more LLMs and/or other generative artificial intelligence processes to identify one or more key-value pairs corresponding to inferred preferences and attributes that may be associated with the family members of the family unit. These terms or phrases may be used as input to one or more LLMs and/or other generative artificial intelligence processes, causing the one or more LLMs and/or other generative artificial intelligence processes to identify one or more key-value pairs corresponding to inferred preferences and attributes that may be associated with the family members of the family unit. Additionally, the one or more LLMs and/or other generative artificial intelligence processes may further calculate an inference confidence score for each key-value pair corresponding to an inferred preference or attribute identified through evaluation of the structured and unstructured data.

As noted above, in some instances, family members may be prompted to upload images, recordings, and/or other media corresponding to a task being collectively performed by the family members. Returning to an earlier illustrative example, a task recommendation system may prompt one or more family members engaged in hiking activities within the North Cascades National Park to upload images of their hiking activities. Further, the task recommendation system may prompt the one or more family members to upload a recording of these one or more family members reaching the end of the Sahale Arm Trail, indicating their emotions upon having achieved the end of their journey. The task recommendation system may provide these images and recordings to the family profiling system, which may process these images and recordings using the aforementioned computer vision and computer audition models to extract one or more key-value pairs corresponding to inferred preferences and attributes that may be associated with the family members of the family unit. Additionally, the computer vision and computer audition models may further calculate an inference confidence score for each key-value pair corresponding to an inferred preference or attribute identified through evaluation of the images and recordings.

At step 606, the family profiling system may determine whether a family member preference or attribute has been identified that can be added to an existing family member profile. As noted above, each inferred preference or attribute may be assigned an inference confidence score. In an embodiment, the family profiling system evaluates the inference confidence score associated with each received inferred preference and attribute to determine whether the inferred preference and attribute should be processed further. For instance, the family profiling system may establish a confidence threshold that may be used to determine whether an inferred preference or attribute extracted from a user response can be considered a profile attribute that may be added to a user profile. If an inferred preference or attribute extracted from a response is assigned an inference confidence score that is below the confidence threshold, the family profiling system may automatically determine that the inferred preference or attribute has a low likelihood of being a profile attribute that may be incorporated into a family member profile. Accordingly, the family profiling system, at step 608, may filter out the key-value pair corresponding to this inferred preference or attribute. Alternatively, if an inferred preference or attribute extracted from a response is assigned an inference confidence score that is equal to or greater than the confidence threshold, the family profiling system may determine that the inferred preference or attribute corresponds to a profile attribute that may be added to a family member profile.

At step 610, for any identified key-value pairs having inference confidence scores greater than or equal to the inference confidence threshold, the family profiling system may generate corresponding family member profile attributes that may be assigned to different family member profiles. For each new family member profile attribute, the family profiling system may incorporate the corresponding inference confidence score to denote a level of confidence that the attribute accurately reflects a characteristic of the corresponding family member.

At step 612, the family profiling system may evaluate these new family member profile attributes against existing family member profile attributes indicated in existing family member profiles and according to previously performed attribute verification processes. For instance, the family profiling system may evaluate a new family member profile attribute and a corresponding existing family member profile according to a knowledge graph and vectors store from the user profile database to determine whether to merge the new family member profile attribute with the existing family member profile. For instance, a family member profile may include data corresponding to different attributes that have been confirmed by the corresponding family member or rejected by the corresponding family member. The family profiling system, through the one or more LLMs or other generative artificial intelligence processes and using the knowledge graph and vectors store, may compare a newly identified family member attribute to the family member attributes defined in the family member profiles associated with the family unit and the data corresponding to confirmed and rejected attributes to determine, at step 614, whether the newly identified family member attribute may be merged with an existing family member profile.

In an embodiment, if the newly identified family member attribute conflicts with an existing family member attribute provided in an existing family member profile, the family profiling system may compare the inference confidence score assigned to each of these family member attributes to select which family member attribute may be applied to the family member profile. For instance, if a newly identified family member attribute has a higher inference confidence score than an existing family member attribute indicated within a family member profile, the family profiling system may determine that the new identified family member attribute may replace the existing family member attribute, as there is a greater level of confidence that the newly identified family member attribute accurately reflects the characteristics of the family member. Alternatively, if the inference confidence score associated with the newly identified family member attribute is not greater than the inference confidence score for an existing family member attribute indicated in the existing family member profile, the family profiling system may determine that the newly identified family member attribute should not replace the existing family member attribute. However, in either scenario, the family profiling system may update the knowledge graph and vectors store to provide an indication of the inference confidence score of any identified family member attribute that has been added to a family member profile or has been rejected from a family member profile. This may provide further context for any newly identified family member attributes that may be used to either boost or reduce the newly calculated inference confidence score for the newly identified family member attributes. For example, if a particular family member attribute is identified multiple times for a particular family member (as indicated through the knowledge graph and vectors store), the family profiling system may determine that there is a greater level of confidence of the family member attribute accurately defining one or more characteristics of the family member. Thus, this data may be used by the one or more LLMs or other generative artificial intelligence processes to adjust the initial inference confidence score for this family member attribute.

Based on the aforementioned evaluation of the newly identified family member attributes, the family profiling system, at step 614, may determine whether to merge these newly identified family member attributes with existing family member profiles. As noted above, if the family profiling system determines that a newly identified family member attribute was previously rejected by the corresponding family member, the family profiling system, at step 616, may filter out this family member attribute. Alternatively, if the newly identified family member attribute has not been previously associated with the family member or is associated with an existing family member attribute within the family member profile, the family profiling system, at step 618, may update the family member profile to merge this newly identified family member attribute with the family member profile to associate this attribute with the family member. As noted above, if there is a conflict between the newly identified family member attribute and an existing family member attribute expressed in the family member profile, the family profiling system may compare the inference confidence score assigned to each of these family member attributes to select which family member attribute may be applied to the family member profile.

As noted above, the family profiling system continuously, and in real-time, processes structured and unstructured data, images, recordings, and other media from different ongoing communications sessions and from the third-party data sources to continuously update and refine the family member profiles associated with the different family members of a family unit. This may ensure that the family member profiles accurately convey the unique attributes of each family member within the family unit. Further, this may ensure that the relationships between these family members as defined through the family member profiles closely mirror the unique dynamics of the family unit. This may allow the family profiling system, through the automated agents, to better communicate with the different family members according to their unique attributes and according to the identified dynamics of the family unit.

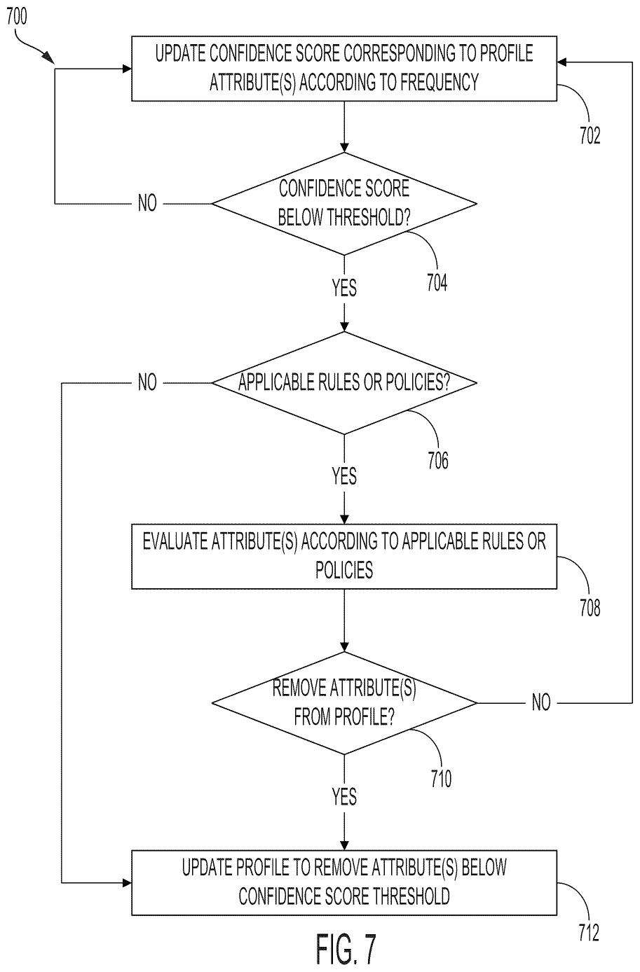

FIG. 7 shows an illustrative example of a process 700 for maintaining different preferences and attributes corresponding to family-based user profiles over time in accordance with at least one embodiment. The process 700 may be performed by the family profiling system and its various components, as described above in connection with FIGS. 1-3. At step 702, the family profiling system may update the confidence score corresponding to a set of profile attributes according to the frequency of utterances associated with this set of profile attributes. As noted above, the family profiling system continuously monitors and tracks the frequency in which previously identified attributes are encountered for the different family members associated with a family unit and for the family unit itself. When an attribute is added to a family member profile or family unit profile, the family profiling system may assign this attribute an initial confidence score, which may correspond to the inference confidence score previously calculated by the data extraction module. As new structured and unstructured data is processed to identify different attributes associated with different family members and the family unit as a whole, the family profiling system may dynamically update the confidence score for each existing attribute depending on whether the existing attribute is represented in the newly identified attributes. For instance, if the family profiling system determines that a new utterance of the attribute has not been detected, the family profiling may dynamically update the confidence score corresponding to this attribute to indicate a lower relevance of the attribute. Returning to an earlier illustrative example, if a family member profile denotes that a particular family member enjoys crocheting, but the family profiling system does not receive any proposed attributes that would reinforce this family member's enjoyment of crocheting, the family profiling system may reduce the confidence score corresponding to this attribute.

At step 704, the family profiling system may evaluate the updated confidence score for each attribute to determine whether the updated confidence score has fallen below a confidence score threshold for relevant attributes. If the updated confidence score does not fall below this confidence score threshold, the family profiling system may maintain the corresponding attribute within the applicable profile and restart the process 700 for this attribute by continuing to monitor new utterances of different family member and family unit attributes.

If the family profiling system determines that the updated confidence score for a particular attribute has fallen below the confidence score threshold, the family profiling system, at step 706, may determine whether there are any rules or policies that may be applicable to the particular attribute and that may define certain actions that are to be performed in response to the attribute's confidence score falling below the confidence score threshold. As noted above, certain attribute types or categories may be deemed fundamental and may not be removed even if the confidence score for an attribute within any of these attribute types or categories falls below the confidence score threshold. Further, certain attribute types or categories may be subject to different rules or policies that may define what actions are to be performed if the confidence score of an attribute associated with any of these attribute types or categories falls below the confidence threshold. If the attribute is not subject to any rules or policies and is not categorized as being fundamental, the family profiling system, at step 712, may update the corresponding family member profile or family unit profile to remove the attribute from the profile, as this attribute may no longer be relevant.

If the family profiling system determines that the attribute is subject to one or more applicable rules or policies, the family profiling system, at step 708, may evaluate the attribute according to these one or more applicable rules or policies to determine, at step 710, whether to remove the attribute from the corresponding family member profile or family unit profile. As noted above, an applicable rule or policy may define one or more actions that may be performed as a result of a corresponding confidence score having fallen below the confidence score threshold. For example, an action may include prompting a family member to confirm whether the attribute is still relevant to the family member. Based on the response from the family member, the family profiling system may determine whether to maintain or remove the particular attribute. As another illustrative example, the applicable rules or policies may denote a less stringent confidence score threshold for the particular attribute type or category such that the attribute may be maintained within the family member or family unit profile even if the confidence score falls below the initial confidence score threshold. If the confidence score for the attribute, at a later time, falls below the confidence threshold denoted in the applicable rules or policies, the family profiling system may remove the attribute from the profile, prompt a family member to determine whether the attribute is still relevant, or any other such action as defined in the applicable rules or policies.

If the family profiling system determines, based on its evaluation of the applicable rules or policies, that the attribute may be maintained in the corresponding family member profile or family unit profile, the family profiling system may restart the process 700 for this attribute by continuing to monitor new utterances of different family member and family unit attributes. However, if the family profiling system determines that the attribute is to be removed from the corresponding profile based on its evaluation of the applicable rules or policies, the family profiling system, at step 712, may update the profile to remove this attribute.

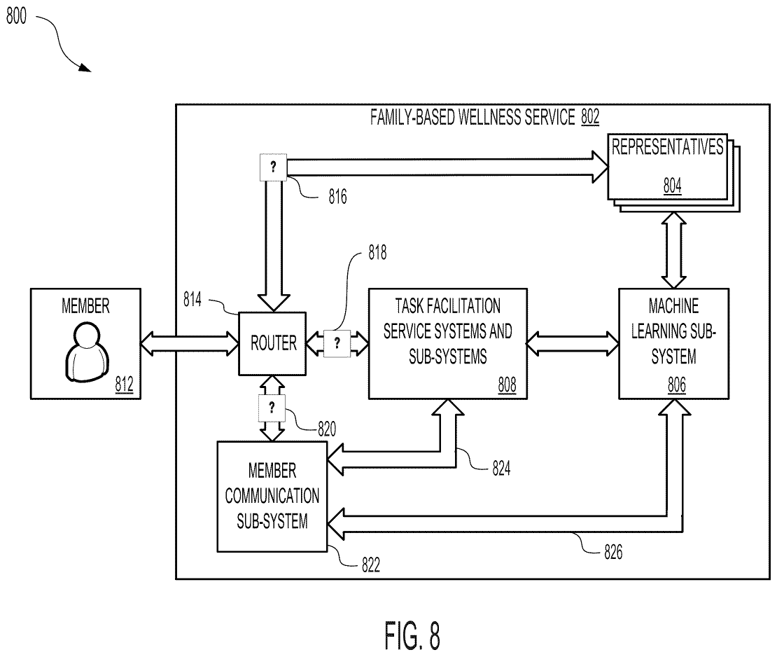

FIG. 8 shows an illustrative example of an environment 800 in which communications with members are processed in accordance with at least one embodiment. In an embodiment, operations performed by representatives 804 are partially and/or fully performed using one or more machine learning algorithms, artificial intelligence systems and/or computational models. For example, as the representatives 804 perform or otherwise coordinate performance of tasks on behalf of a member 812, the task facilitation service 802 may update a profile of the member 812 and/or a computational model of the profile of the member 812.

In an embodiment, as the representatives 804 perform or otherwise coordinate performance of tasks on behalf of a member 812, the task facilitation service 802 updates a profile of the member 812 and/or a computational model of the profile of the member 812 continuously. For example, as a member 812 communicates with a system of the task facilitation service 802, the task facilitation service 802 may update the profile of the member 812 and/or a computational model of the profile of the member 812 continuously during the course of the interaction.

In an embodiment, as the representatives 804 perform or otherwise coordinate performance of tasks on behalf of a member 812, the task facilitation service 802 updates a profile of the member 812 and/or a computational model of the profile of the member 812 dynamically. For example, as a task is performed on behalf of a member 812, a vendor performing the task may provide regular updates to the task facilitation service 802 and the task facilitation service 802 may update the profile of the member 812 and/or a computational model of the profile of the member 812 dynamically at each update from the vendor.

In an embodiment, as the representatives 804 perform or otherwise coordinate performance of tasks on behalf of a member 812, the task facilitation service 802 updates a profile of the member 812 and/or a computational model of the profile of the member 812 automatically. For example, when a proposal is generated for the member, the task facilitation service 802 may update the profile of the member 812 and/or a computational model of the profile of the member 812 automatically as part of the proposal generation process.

In an embodiment, as the representatives 804 perform or otherwise coordinate performance of tasks on behalf of a member 812, the task facilitation service 802 updates a profile of the member 812 and/or a computational model of the profile of the member 812 in real-time. For example, when a member 812 accepts a proposal, the task facilitation service 802 may update the profile of the member 812 and/or a computational model of the profile of the member 812 at the time that the proposal acceptance is provided, rather than delaying the update.

In an embodiment, the task facilitation service 802 updates a profile of the member 812 and/or a computational model of the profile of the member 812 using a machine learning sub-system 806 of the task facilitation service 802. In an embodiment, a machine learning sub-system 806 is a component of the task facilitation service 802 that is configured to implement machine learning algorithms, artificial intelligence systems, and/or computation models. In an example, a machine learning sub-system 806 may use various algorithms to train a machine learning model using sample and/or live data. Additionally, a machine learning sub-system 806 may update the machine learning model as new data is received. In another example, the machine learning sub-system 806 may train and/or update various artificial intelligence systems or generate, train and/or update various computational models. For example, a computational model of the profile of the member 812 may be generated, trained and/or updated by the machine learning sub-system 806 as new information is received about the member 812.

In an embodiment, after the profile of the member 812 and/or a computational model of the profile of the member 812 has been updated over a period of time (e.g., six months, a year, etc.) and/or over a set of tasks (e.g., twenty tasks, thirty tasks, etc.), systems of the task facilitation service 802 (e.g., a task recommendation system) utilize one or more machine learning algorithms, artificial intelligence systems and/or computational models to generate new tasks continuously, automatically, dynamically, and in real-time. For example, the task recommendation system may generate new tasks based on the various attributes of the member's profile (e.g., historical data corresponding to member-representative communications, member feedback corresponding to representative performance and presented tasks/proposals, etc.) with or without representative interaction. In an embodiment, systems of task facilitation service 802 (e.g., a task recommendation system) can automatically communicate with the member 812 to obtain any additional information needed and can also generate proposals that may be presented to the member 812 for performance of these tasks.

In the example illustrated in FIG. 8, communications between the member 812 and the task facilitation service 802 may be routed to one or more entities within the task facilitation service 802. The example illustrated in FIG. 8 shows a communication router 814 (referred to in the illustration as a “router”) however, as may be contemplated and as illustrated in FIG. 8, the router 814 is an abstract representation of one or more techniques for routing communications between entities. Accordingly, communications from the member 812 to the task facilitation service 802 may be routed to one or more entities of the task facilitation service and communications from the one or more entities of the task facilitation service 802 may be routed back to the member 812.

In the example illustrated in FIG. 8, the representatives 804 can monitor communications between task facilitation service systems and/or sub-systems 808 and the member 812 to ensure that the interaction maintains a positive polarity as described herein because the communications can be routed 816 to the representatives 804 and also routed 818 to task facilitation service systems and/or sub-systems 808. For example, if a member 812 is interacting with the task recommendation system, the representatives 804 can determine whether the member 812 is satisfied with the interaction. If the representatives 804 determine that the conversation has a negative polarity (e.g., that the member 812 is not satisfied with the interaction), the representatives 804 may intervene to improve the interaction.

Similarly, other interactions between task facilitation service systems and/or sub-systems 808 and the member 812 may be routed 820 to a member communication sub-system 822 which may be configured to monitor the interactions between task facilitation service systems and/or sub-systems 808 and the member 812. In an embodiment, the member communication sub-system 822 can be configured to intercept the interactions between task facilitation service systems and/or sub-systems 808 and the member 812 (using, for example, the router 814). In such an embodiment, all such interactions can be routed 820 between the member 812 and the member communication sub-system 822 and can be routed 824 between the member communication sub-system 822 and the task facilitation service systems and/or sub-systems 808. In such an embodiment, interactions between the task facilitation service systems and/or sub-systems 808 and the member 812 may not be routed 818 directly. In such an embodiment, the representatives 804 may still monitor interactions between task facilitation service systems and/or sub-systems 808 and the member 812 to ensure that the interaction maintains a positive polarity as described above (e.g., by routing 816 the interactions to the representatives 804).

In an embodiment, the representatives 804 can interact with the machine learning sub-system 806 to update the profile of the member indicating changing member preferences based on an interaction between the representatives 804 the member 812. In an embodiment, the task facilitation service systems and/or sub-systems 808 can interact with the machine learning sub-system 806 to update the profile of the member when, for example, a proposal is accepted or rejected. Additionally, as illustrated in FIG. 8, the interactions between the task facilitation service 802 and the member 812 can be additionally routed 826 between the member communication sub-system 822 and the machine learning sub-system 806. Accordingly, interactions between the member 812 and, for example, a proposal creation sub-system may be used to update the profile of the member as a proposal is created.

Thus, unlike automated customer service systems and environments, wherein the systems and environment may have little or no knowledge of users interacting with agents and/or other automated systems, task facilitation service systems and/or sub-systems 808 can update the profile of the member 812 and/or a computational model of the profile of the member 812 continuously, dynamically, automatically, and/or in real-time. For example, task facilitation service systems and/or sub-systems 808 can update the profile of the member 812 and/or a computational model of the profile of the member 812 using the machine learning sub-system 806 as described herein. Accordingly, task facilitation service systems and/or sub-systems 808 can update the profile of the member 812 and/or a computational model of the profile of the member 812 to provide up-to-date information about the member based on the member's automatic interaction with the task facilitation service 802, based on the member's interaction with the representative 804, and/or based on tasks performed on behalf of the member 812 over time. This information may also be updated continuously, automatically, dynamically, and/or in real-time as tasks and/or proposals are created, proposed, and performed for the member 812. This information may also be used by the task facilitation service 802 to anticipate, identify, and present appropriate or intelligent interactions with the member 812 (e.g., in response to member 812 queries, needs, and/or goals).

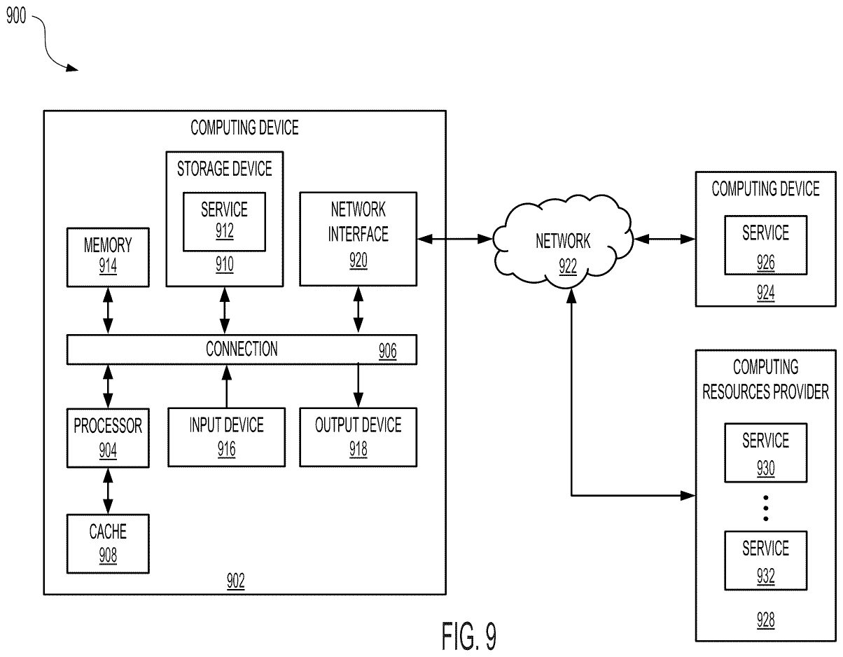

FIG. 9 illustrates a computing system architecture 900, including various components in electrical communication with each other, in accordance with some embodiments. The example computing system architecture 900 illustrated in FIG. 9 includes a computing device 902, which has various components in electrical communication with each other using a connection 906, such as a bus, in accordance with some implementations. The example computing system architecture 900 includes a processing unit 904 that is in electrical communication with various system components, using the connection 906, and including the system memory 914. In some embodiments, the system memory 914 includes read-only memory (ROM), random-access memory (RAM), and other such memory technologies including, but not limited to, those described herein. In some embodiments, the example computing system architecture 900 includes a cache 908 of high-speed memory connected directly with, in close proximity to, or integrated as part of the processor 904. The system architecture 900 can copy data from the memory 914 and/or the storage device 910 to the cache 908 for quick access by the processor 904. In this way, the cache 908 can provide a performance boost that decreases or eliminates processor delays in the processor 904 due to waiting for data. Using modules, methods and services such as those described herein, the processor 904 can be configured to perform various actions. In some embodiments, the cache 908 may include multiple types of cache including, for example, level one (L1) and level two (L2) cache. The memory 914 may be referred to herein as system memory or computer system memory. The memory 914 may include, at various times, elements of an operating system, one or more applications, data associated with the operating system or the one or more applications, or other such data associated with the computing device 902.

Other system memory 914 can be available for use as well. The memory 914 can include multiple different types of memory with different performance characteristics. The processor 904 can include any general purpose processor and one or more hardware or software services, such as service 912 stored in storage device 910, configured to control the processor 904 as well as a special-purpose processor where software instructions are incorporated into the actual processor design. The processor 904 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 904 can be a microprocessor, a microcontroller, a digital signal processor (“DSP”), or a combination of these and/or other types of processors. In some embodiments, the processor 904 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 900, an input device 916 can represent any number of input mechanisms, such as a microphone for speech, a touch-sensitive screen for gesture or graphical input, keyboard, mouse, motion input, pen, and other such input devices. An output device 918 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 900. In some embodiments, the input device 916 and/or the output device 918 can be coupled to the computing device 902 using a remote connection device such as, for example, a communication interface such as the network interface 920 described herein. In such embodiments, the communication interface can govern and manage the input and output received from the attached input device 916 and/or output device 918. As may be contemplated, there is no restriction on operating on any particular hardware arrangement and accordingly the basic features here may easily be substituted for other hardware, software, or firmware arrangements as they are developed.

In some embodiments, the storage device 910 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 910 can include hardware and/or software services such as service 912 that can control or configure the processor 904 to perform one or more functions including, but not limited to, the methods, processes, functions, systems, and services described herein in various embodiments. In some embodiments, the hardware or software services can be implemented as modules. As illustrated in example computing system architecture 900, the storage device 910 can be connected to other parts of the computing device 902 using the system connection 906. In an embodiment, a hardware service or hardware module such as service 912, that performs a function can include a software component stored in a non-transitory computer-readable medium that, in connection with the necessary hardware components, such as the processor 904, connection 906, cache 908, storage device 910, memory 914, input device 916, output device 918, and so forth, can carry out the functions such as those described herein.

The disclosed processed for generating and executing experience recommendations can be performed using a computing system such as the example computing system illustrated in FIG. 9, using one or more components of the example computing system architecture 900. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating and executing experience recommendations described herein by, for example, executing code using a processor such as processor 904 wherein the code is stored in memory such as memory 914 as described herein. One or more of a user device, a provider server or system, a database system, or other such devices, services, or systems may include some or all of the components of the computing system such as the example computing system illustrated in FIG. 9, using one or more components of the example computing system architecture 900 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 928. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 904 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 914 can be coupled to the processor 904 by, for example, a connector such as connector 906, or a bus. As used herein, a connector or bus such as connector 906 is a communications system that transfers data between components within the computing device 902 and may, in some embodiments, be used to transfer data between computing devices. The connector 906 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 914 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 914 can also include magnetic or optical data storage media including read-only (e.g., CD ROM and DVD ROM) or otherwise (e.g., CD or DVD). The memory can be local, remote, or distributed.

As described above, the connector 906 (or bus) can also couple the processor 904 to the storage device 910, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 910. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 906 can also couple the processor 904 to a network interface device such as the network interface 920. The interface can include one or more of a modem or other such network interfaces including, but not limited to those described herein. It will be appreciated that the network interface 920 may be considered to be part of the computing device 902 or may be separate from the computing device 902. The network interface 920 can include one or more of an analog modem, Integrated Services Digital Network (ISDN) modem, cable modem, token ring interface, satellite transmission interface, or other interfaces for coupling a computer system to other computer systems. In some embodiments, the network interface 920 can include one or more input and/or output (I/O) devices. The I/O devices can include, by way of example but not limitation, input devices such as input device 916 and/or output devices such as output device 918. For example, the network interface 920 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and decendents, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 902 can be connected to one or more additional computing devices such as computing device 924 via a network 922 using a connection such as the network interface 920. In such embodiments, the computing device 924 may execute one or more services 926 to perform one or more functions under the control of, or on behalf of, programs and/or services operating on computing device 902. In some embodiments, a computing device such as computing device 924 may include one or more of the types of components as described in connection with computing device 902 including, but not limited to, a processor such as processor 904, a connection such as connection 906, a cache such as cache 908, a storage device such as storage device 910, memory such as memory 914, an input device such as input device 916, and an output device such as output device 918. In such embodiments, the computing device 924 can carry out the functions such as those described herein in connection with computing device 902. In some embodiments, the computing device 902 can be connected to a plurality of computing devices such as computing device 924, each of which may also be connected to a plurality of computing devices such as computing device 924. Such an embodiment may be referred to herein as a distributed computing environment.

The network 922 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 922 can be wired connections, wireless connections, or combinations thereof. Communications via the network 922 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 922, within the computing device 902, within the computing device 924, or within the computing resources provider 928 can include information, which also may be referred to herein as content. The information may include text, graphics, audio, video, haptics, and/or any other information that can be provided to a user of the computing device such as the computing device 902. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 902 and presented to a user of the computing device 902 using forms that are perceptible via sight, sound, smell, taste, touch, or other such mechanisms. In some embodiments, communications over the network 922 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 902 and/or the computing device 924 can be connected to a computing resources provider 928 via the network 922 using a network interface such as those described herein (e.g. network interface 920). In such embodiments, one or more systems (e.g., service 930 and service 932) hosted within the computing resources provider 928 (also referred to herein as within “a computing resources provider environment”) may execute one or more services to perform one or more functions under the control of, or on behalf of, programs and/or services operating on computing device 902 and/or computing device 924. Systems such as service 930 and service 932 may include one or more computing devices such as those described herein to execute computer code to perform the one or more functions under the control of, or on behalf of, programs and/or services operating on computing device 902 and/or computing device 924.

For example, the computing resources provider 928 may provide a service, operating on service 930 to store data for the computing device 902 when, for example, the amount of data that the computing device 902 exceeds the capacity of storage device 910. In another example, the computing resources provider 928 may provide a service to first instantiate a virtual machine (VM) on service 932, use that VM to access the data stored on service 932, perform one or more operations on that data, and provide a result of those one or more operations to the computing device 902. Such operations (e.g., data storage and VM instantiation) may be referred to herein as operating “in the cloud,” “within a cloud computing environment,” or “within a hosted virtual machine environment,” and the computing resources provider 928 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 928 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 930 and service 932 may implement versions of various services (e.g., the service 912 or the service 926) on behalf of, or under the control of, computing device 902 and/or computing device 924. Such implemented versions of various services may involve one or more virtualization techniques so that, for example, it may appear to a user of computing device 902 that the service 912 is executing on the computing device 902 when the service is executing on, for example, service 930. As may also be contemplated, the various services operating within the computing resources provider 928 environment may be distributed among various systems within the environment as well as partially distributed onto computing device 924 and/or computing device 902.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 5-7). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
obtaining conversation data, wherein the conversation data corresponds to an ongoing communications session between a set of users and an automated agent;
converting the conversation data into a set of key-value pairs of inferred user attributes, wherein the conversation data is converted into the set of key-value pairs using one or more large language models (LLMs) dynamically trained to extract different inferred user attributes from different conversation data;
evaluating a set of profiles to identify a set of existing attributes associated with the set of users and to a family unit, wherein the family unit is a grouping of the set of users;
updating the set of profiles, wherein the set of profiles is updated by processing the set of key-value pairs and the set of existing attributes to generate a set of merged attributes corresponding to the set of users and the family unit, and wherein the set of merged attributes is generated by verifying feedback corresponding to the set of existing attributes;
processing the updated set of profiles through a trained machine learning algorithm to identify one or more tasks for improving a set of metrics associated with the family unit; and
providing the one or more tasks through the ongoing communications session.

2. The computer-implemented method of claim 1, further comprising:
monitoring, in real-time, performance of the one or more tasks; and
dynamically performing one or more actions to improve the performance of the one or more tasks, wherein the one or more actions are performed based on the set of profiles.

3. The computer-implemented method of claim 1, further comprising:
generating a new profile corresponding to a new user associated with the family unit, wherein the new profile is generated based on a determination that a subset of the set of key-value pairs does not correspond to an existing user from the set of users.

4. The computer-implemented method of claim 1, wherein the one or more LLMs are further dynamically trained to generate prompts for additional conversation data, and wherein the prompts are generated based on a context of the conversation data and the set of key-value pairs.

5. The computer-implemented method of claim 1, further comprising:
calculating inference confidence scores for the set of key-value pairs, wherein an inference confidence score denotes a likelihood that a corresponding inferred user attribute can be associated with a user profile; and
processing the inference confidence scores against existing inference confidence scores corresponding to the set of existing attributes to generate the set of merged attributes.

6. The computer-implemented method of claim 1, wherein the set of profiles is updated according to a knowledge graph and a vectors store, and wherein the knowledge graph and the vectors store provide indications of previously verified and previously rejected user attributes.

7. The computer-implemented method of claim 1, further comprising:
identifying a set of idiosyncrasies corresponding to the set of users, wherein the set of idiosyncrasies is identified based on the updated set of profiles; and
generating one or more motivators according to the set of idiosyncrasies, wherein the one or more motivators are provided with the one or more tasks to motivate the set of users to complete the one or more tasks.

8. A system, comprising:
one or more processors; and
memory storing thereon instructions that, as a result of being executed by the one or more processors, cause the system to:
obtain conversation data, wherein the conversation data corresponds to an ongoing communications session between a set of users and an automated agent;
convert the conversation data into a set of key-value pairs of inferred user attributes, wherein the conversation data is converted into the set of key-value pairs using one or more large language models (LLMs) dynamically trained to extract different inferred user attributes from different conversation data;
evaluate a set of profiles to identify a set of existing attributes associated with the set of users and to a family unit, wherein the family unit is a grouping of the set of users;
update the set of profiles, wherein the set of profiles is updated by processing the set of key-value pairs and the set of existing attributes to generate a set of merged attributes corresponding to the set of users and the family unit, and wherein the set of merged attributes is generated by verifying feedback corresponding to the set of existing attributes;
process the updated set of profiles through a trained machine learning algorithm to identify one or more tasks for improving a set of metrics associated with the family unit; and
provide the one or more tasks through the ongoing communications session.

9. The system of claim 8, wherein the instructions further cause the system to:
monitor, in real-time, performance of the one or more tasks; and
dynamically perform one or more actions to improve the performance of the one or more tasks, wherein the one or more actions are performed based on the set of profiles.

10. The system of claim 8, wherein the instructions further cause the system to:
generate a new profile corresponding to a new user associated with the family unit, wherein the new profile is generated based on a determination that a subset of the set of key-value pairs does not correspond to an existing user from the set of users.

11. The system of claim 8, wherein the one or more LLMs are further dynamically trained to generate prompts for additional conversation data, and wherein the prompts are generated based on a context of the conversation data and the set of key-value pairs.

12. The system of claim 8, wherein the instructions further cause the system to:
calculate inference confidence scores for the set of key-value pairs, wherein an inference confidence score denotes a likelihood that a corresponding inferred user attribute can be associated with a user profile; and
process the inference confidence scores against existing inference confidence scores corresponding to the set of existing attributes to generate the set of merged attributes.

13. The system of claim 8, wherein the set of profiles is updated according to a knowledge graph and a vectors store, and wherein the knowledge graph and the vectors store provide indications of previously verified and previously rejected user attributes.

14. The system of claim 8, wherein the instructions further cause the system to:
identify a set of idiosyncrasies corresponding to set of users, wherein the set of idiosyncrasies is identified based on the updated set of profiles; and
generate one or more motivators according to the set of idiosyncrasies, wherein the one or more motivators are provided with the one or more tasks to motivate the set of users to complete the one or more tasks.

15. A non-transitory computer-readable storage medium storing thereon executable instructions that, as a result of being executed by one or more processors of a computer system, cause the computer system to:
obtain conversation data, wherein the conversation data corresponds to an ongoing communications session between a set of users and an automated agent;
convert the conversation data into a set of key-value pairs of inferred user attributes, wherein the conversation data is converted into the set of key-value pairs using one or more large language models (LLMs) dynamically trained to extract different inferred user attributes from different conversation data;
evaluate a set of profiles to identify a set of existing attributes associated with the set of users and to a family unit, wherein the family unit is a grouping of the set of users;
update the set of profiles, wherein the set of profiles is updated by processing the set of key-value pairs and the set of existing attributes to generate a set of merged attributes corresponding to the set of users and the family unit, and wherein the set of merged attributes is generated by verifying feedback corresponding to the set of existing attributes;
process the updated set of profiles through a trained machine learning algorithm to identify one or more tasks for improving a set of metrics associated with the family unit; and
provide the one or more tasks through the ongoing communications session.

16. The non-transitory computer-readable storage medium of claim 15, wherein the executable instructions further cause the computer system to:
monitor, in real-time, performance of the one or more tasks; and
dynamically perform one or more actions to improve the performance of the one or more tasks, wherein the one or more actions are performed based on the set of profiles.

17. The non-transitory computer-readable storage medium of claim 15, wherein the executable instructions further cause the computer system to:
generate a new profile corresponding to a new user associated with the family unit, wherein the new profile is generated based on a determination that a subset of the set of key-value pairs does not correspond to an existing user from the set of users.

18. The non-transitory computer-readable storage medium of claim 15, wherein the one or more LLMs are further dynamically trained to generate prompts for additional conversation data, and wherein the prompts are generated based on a context of the conversation data and the set of key-value pairs.

19. The non-transitory computer-readable storage medium of claim 15, wherein the executable instructions further cause the computer system to:
calculate inference confidence scores for set of key-value pairs, wherein an inference confidence score denotes a likelihood that a corresponding inferred user attribute can be associated with a user profile; and
process the inference confidence scores against existing inference confidence scores corresponding to the set of existing attributes to generate the set of merged attributes.

20. The non-transitory computer-readable storage medium of claim 15, wherein the set of profiles is updated according to a knowledge graph and a vectors store, and wherein the knowledge graph and the vectors store provide indications of previously verified and previously rejected user attributes.

21. The non-transitory computer-readable storage medium of claim 15, wherein the executable instructions further cause the computer system to:
identify a set of idiosyncrasies corresponding to the set of users, wherein the set of idiosyncrasies is identified based on the updated set of profiles; and
generate one or more motivators according to the set of idiosyncrasies, wherein the one or more motivators are provided with the one or more tasks to motivate the set of users to complete the one or more tasks.
